(19) United States
(12) Patent Application Publication
(10) Pub. No.: US 2012/0138820 A1
(43) Pub. Date: Jun. 7, 2012

(54) System and method for detecting and visualizing ignitable liquid residues using hyperspectral imaging

(75) Inventors: Cara Plese, Cranberry Township, PA (US); Sara Nedley, Wexford, PA (US); David Exline, Gibsonia, PA (US)

(73) Assignee: ChemImage Corporation, Pittsburgh, PA (US)

(21) Appl. No.: 13/373,563

(22) Filed: Nov. 17, 2011

Related U.S. Application Data
(60) Provisional application No. 61/458,236, filed on Nov. 19, 2010.

(51) Int. Cl. G01N 21/64

(52) U.S. Cl. 250/459.1; 250/458.1; 250/200; 250/208.1

(57) ABSTRACT

The present disclosure provides for a system and method for detecting, identifying and/or distinguishing between ignitable liquid residues on various types of substrates. A method may comprise generating a fluorescence data set representative of a substrate, which may comprise a fluorescence hyperspectral image. This fluorescence data set may be analyzed to determine the presence and/or identity of an ignitable liquid residue. Regions of a substrate comprising an ignitable liquid residue may further be interrogated using Raman techniques. This may comprise generating and analyzing a Raman data set representative of a region of interest of a substrate to thereby identify an ignitable liquid residue. A system may comprise an illumination source, a tunable filter, and a first detector configured to generate a fluorescence data set. The system may further comprise a second detector configured to generate a Raman data set representative of a region of interest of a substrate.

### RELATED APPLICATIONS

This Application claims priority under 35 U.S.C. §119(e) to pending U.S. Provisional Patent Application No. 61/458,236, filed on Nov. 19, 2010, entitled “Hyperspectral Imaging as a Method For Detecting and Visualizing Ignitable Liquid Residues on Clothing and Carpeting,” which is hereby incorporated by reference in its entirety.

### BACKGROUND

Annually, arson is the cause of several hundred deaths as well as billions of dollars worth of damage in the United States alone. Even though the instances of arson are numerous, the offenders of these crimes are difficult to convict since often times the evidence linking them to the crime is destroyed in the fire. Arsonists typically use ignitable liquids, also sometimes called accelerants, so that the fire will quickly ignite and engulf the arson scene in flame. These ignitable liquids are usually petroleum products; specifically, gasoline, kerosene, and diesel fuel are most often used because they are cheap, easily accessible in large amounts, and flammable. When these ignitable liquids make contact with a material, such as clothing or carpet, it is possible for them to leave a residue, referred to herein as an ignitable liquid residue (ILR).

Due to federal mandate, dyes and markers, called ‘tags,’ are added to certain petroleum products during the refining process so that they can be quickly distinguished visually. Petroleum products need to be distinguished for several reasons including easy discrimination between brands and grades, products that are taxed differently are tagged differently, and for proprietary reasons. Petroleum products are also tagged as a deterrent for mixing higher grade product with a lesser grade, and additionally to deter theft. Fluorescent petroleum markers which have been established include phthalocyanines and naphthocyanines.

There are several methods currently in use for detecting and analyzing ILRs, both in burned debris and on clothing as well as on other substrates; most of these methods detect and analyze the hydrocarbon component of the ILRs. Detection canines are one option for ILR detection. These canines are specifically trained to alert to areas which contain the scent of certain ILRs, and their ability has been tested and documented. Nowlan et al compared the performance of a detection canine to that of an ignitable liquid absorbent (ILA), a compound which undergoes a color change to indicate the presence of hydrocarbons, therefore possibly indicating the presence of an ILR. The canines proved to positively detect more ILR samples than the ILA. Recently, experimentation has been conducted using alternative light sources along with various barrier filters to locate flammable liquids on white fabric. Gasoline, diesel fuel, and mineral spirits were successfully detected in this manner.

Solid phase microextraction with gas chromatography (SPME-GC) is another method which has been reported to successfully detect and analyze ILRs rapidly and with minimal sample preparation. SPME is a method of sampling ILRs directly and analyzing the extract with another method, such as gas chromatography (GC) in one single step. When compared to the traditionally used activated carbons strip (ACS) extraction method, solid phase microextraction (SPME) proved to be a viable alternative.

Almirall et al tested the ability of SPME-GC to detect residues of gasoline, diesel fuel, and charcoal lighter fluid on human skin. This method was successful at detecting all three liquids on human skin, however only up to 3.5 hours after deposition. A study was conducted using headspace single drop microextraction (HS-SDME) followed by GC with flame ionization detection (GC-FID) to determine ILRs on burned fabric. The HS-SDME method was successful at determining kerosene down to 1.5 μL volumes, along with other ignitable liquids.

Conner et al evaluated the performance of electronic noses to detect ILRs. Conner's results show that the electronic noses were successful at detecting sample substrates which contained ILRs. The electronic noses could also discriminate between samples spiked with ignitable liquids, and other substrates which had not been spiked with the liquids.

Aernecke and Walt studied the use of a fluorescence-based vapor-sensitive microsphere array to detect and classify ignitable liquids both in vapor form and as residues on mock fire debris samples. The microsphere array was successful at detecting ignitable liquids in both forms, and was able to correctly classify greater than 97% of the samples. SPME, HS-SDMS, electronic noses however are unable to detect exactly where on the substrate the residue is located.

Aside from the aforementioned studies regarding the instrumentation used to detect and analyze ILR stains, several studies have been carried out regarding the deposition of ILRs onto suspect clothing and also its persistence through time on such substrates. A study was recently conducted by Coulson et al that evaluated the presence of petrol on the clothing of individuals after they had performed tasks such as pumping gas into their car or using a gasoline powered lawn mower. The results show that during normal use of gasoline, residues were not found on the majority of clothing belonging to the users. Coulson and Morgan-Smith conducted another study which evaluated the amount of petrol left on clothing and shoes after the action of pouring the petrol onto both carpeted and concrete floors. In this study, it was shown that in all scenarios, petrol was found on the shoes of the pourer, and up to 5 mL was recovered on the jeans of the pourer, with decreasing amounts recovered on the upper clothing of the pourer. The results of the Coulson et al studies exemplify that after normal usage of gasoline, it is not necessarily common to have gasoline residues remaining on clothing, however gasoline is commonly found on clothing after the act of pouring gasoline onto floors or walls. This information is important to the investigator when a suspect tries to explain away ILR findings.

Studies have also been conducted which evaluated the occurrence of finding petroleum products, which are commonly used as accelerants in arson cases, in common household products, as well as clothing. According to the findings of Lentini et al, medium and heavy distillates, which encompass both kerosene and diesel fuel, were found both in clothing and in common household products when analyzed with GC-MS. Almirall and Furton similarly found that many compounds which are identified as components of ignitable liquids can also be found in household product substrate matrixes.

Studies regarding the persistence of ignitable liquids on human skin, car carpets, clothing, and flooring have been conducted. Darrer et al experimented on the detection limits of GC with headspace extraction in detecting gasoline on human hands. The results of the Darrer study showed that 1000 μL quantities could not be detected 4 hours after deposition, and 500 μL quantities could not be detected after 2 hours. A study regarding the persistence of gasoline on car carpets was conducted by Cavanagh-Steer et al. Using GC-MS, one 5000 μL gasoline stain was detectable on acoustic padding at 4 weeks after deposition. Some stains between the volumes of 250 μL-5000 μL were detectable after 1 week, and stains of 100 μL could only be detected within 24 hours after deposition. Folkman et al conducted a study determining the rate of evaporation of gasoline and kerosene from multiple substrates commonly encountered in arson investigations. Folkman was able to detect gasoline up to seven days after deposition on carpeting. Folkman also exemplified that the evaporation rate of the ignitable liquids is dependent on several factors including substrate absorption characteristics, however on any tested substrate, gasoline was quicker to evaporate than kerosene.

The need exists for systems and methods for detecting ILRs on various substrates at various time intervals. The present disclosure overcomes the limitations of the prior art by providing techniques that may detect fluorescence stains associated with ILRs, analyze their distribution, and provide information indicative of an ignitable liquid being present at a crime scene.

### SUMMARY OF THE INVENTION

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger targets, in the range of millimeter to meter dimensions, macro lens optics are appropriate. For samples located within relatively inaccessible environments, flexible fiberscope or rigid borescopes can be employed. For very large scale targets, such as planetary targets, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the entire area encompassing the sample simultaneously using an electronically tunable optical imaging filter such as an acousto-optic tunable filter (AOTF) or a LCTF. This may be referred to as “wide-field imaging”. Here, the organic material in such optical filters are actively aligned by applied voltages to produce the desired bandpass and transmission function. The spectra obtained for each pixel of such an image thereby forms a complex data set referred to as a hyperspectral image (HSI) which contains the intensity values at numerous wavelengths or the wavelength dependence of each pixel element in this image.

Spectroscopic devices operate over a range of wavelengths due to the operation ranges of the detectors or tunable filters possible. This enables analysis in the Ultraviolet (UV), visible (VIS), near infrared (NIR), short-wave infrared (SWIR), mid infrared (MIR), long wave infrared (LWIR) wavelengths and to some overlapping ranges. These correspond to wavelengths of about 180-380 nm (UV), 380-700 nm (VIS), 700-2500 nm (NIR), 850-1800 nm (SWIR), 2500-25000 nm (MIR), and 7500-13500 nm (LWIR).

The present disclosure provides for a system and method for detecting ILRs. The present disclosure provides for a novel method of analyzing, detecting, and visualizing ILRs, which may be applied to various substrates, including but not limited to clothing and carpeting. More specifically, the system and method of the present disclosure illustrate the potential capability of hyperspectral imaging (HSI) in the detection ILRs on common unburned clothing fabrics as well as on unburned carpeting.

Fluorescence is the phenomenon of a molecule absorbing a certain wavelength of energy and emitting a photon at a higher wavelength and lower energy. Certain molecules display fluorescence because they contain a functional group called a fluorophore. The fluorophore is specifically responsible for the absorption of energy at a specific wavelength and emission at a lower energy. Fluorophores are commonly rigid due to conjugate double bonds, often in aromatic rings. Conjugate double bonds contain delocalized electrons which stabilize the energy absorbed by the fluorophore, before it is released at a higher wavelength in the form of a photon which is seen as fluorescence.

In one embodiment, the method of the present disclosure provides for the visualization of fluorescence markers remaining in ILR stains (a fluorescence stain), resulting in an image of the residues on the substrate and also a spectrum of the residue. HSI technology has the ability to locate the stain within mm sampling range, which is advantageous to casework when locating very small sampling areas on a substrate for further analysis, and also is not hindered by the hydrocarbon evaporation rate as are the other methods. Having a visualized stain such as provided by HSI can be valuable is the case where a substrate blank would not be available for comparison testing.

The system and method of the present disclosure provide for the detection due to the fluorescence of dyes and biomarkes in petroleum products even after the hydrocarbon portion of the liquid has evaporated. Therefore, the present invention holds potential for detecting residues weeks after deposition. The system and method of the present disclosure overcome the shortcomings of the prior art by enabling visualization of residue materials associated with commonly used accelerant after the portions that are typically characterized by current forensic methods have dissipated. The ability to characterize the remaining components and the ability to visualize their presence, shape, distribution and amount of time they persist are key advantages associated with the system and method provided for herein.

To date, there are no published accounts of using HSI for the analysis of ILRs, specifically the dyes and additives in the stains. HSI technology provides data both in the form of digital images as well as chemical information in the form of a spectrum associated with the sample. The images are collected as a function of wavelength with results in a ‘datacube’ of a stack of images. The images that make up the datacube are collected at manually chosen wavelength intervals throughout a selected region of data collection. For instance, if the data collection was to be performed from the visible region through the short wave near infra-red (Sw-IR) region at 10 nm steps, an image would be collected of the sample reflection at 400 nm, 410 nm, 420 nm et cetera up until 1100 nm. In this particular example, the datacube would have 71 frames, or individual digital images, that being one for every 10 nm of the data collection range. Having multiple image frames to reference allows the maximum contrast between the sample and the background to be found and viewed.

An HSI methodology provides data analysis with minimal to no sample preparation required, and is a nondestructive method which does not compromise the value of the sample being examined. Data is collected in the form of digital images, and a spectrum is provided for each individual pixel in the image. Since HSI analysis is non destructive, it is a useful method of preliminary examination since it does not expend sample which may be limited, and samples that have been examined can be forwarded on for further testing by other instrumentation.

The visual provided by HSI examination can be very valuable in various crime scene scenarios. For example, if a suspect claims that he wiped his hands on his jeans after pouring gasoline into the lawn mower, but a spatter pattern is visualized, the suspect story can be disputed. All of these improvements would arm arson investigators with increased ability of detecting and identifying ILRs during investigations.

The system and method of the present disclosure hold potential for the forensic science market and hold potential for providing investigators with a new method of detecting ILRs. In one embodiment, the system and method disclosed herein may be applied during arson investigations.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

The patent or application file contains at least one drawing executed in color. Copies of this patent or patent application publication with color.

In the drawings:

FIG. 1A is illustrative of a method of the present disclosure.

FIG. 1B is representative of exemplary packaging of a system of the present disclosure.

FIG. 1C is representative of a system of the present disclosure.

FIG. 2 is representative of a spectrum resulting from dividing the spectrum of a multi-component standard by the spectrum of a 99% reflectance standard.

FIG. 3 is representative of a fluorescence spectrum of a standard.

FIG. 4 illustrates ignitable liquid samples.

FIG. 5 illustrates various substrates.

FIG. 6 is representative of liquids used in multi-stain samples.

FIG. 7 is an exemplary schematic of sample deposition on multi-stain samples.

FIG. 8 is representative of background divided spectra of gasoline.

FIG. 9 is representative of background divided spectra of diesel fuel.

FIG. 10 is representative of background divided spectra of gasoline and diesel fuel.

FIG. 11 represents digital images of fabric substrates.

FIG. 12 represents digital images of carpet substrates.

FIG. 13 represents digital images of carpet substrates with diesel fuel.

FIG. 14 illustrates a hyperspectral image of gasoline on white cotton.

FIG. 15 illustrates a hyperspectral image of gasoline on denim.

FIG. 16 illustrates a hyperspectral image of gasoline on carpet.

FIG. 17 illustrates a hyperspectral image of gasoline on carpet.

FIG. 18 illustrates a hyperspectral image of gasoline on carpet.

FIG. 19 illustrates a hyperspectral image of diesel fuel on white cotton.

FIG. 20 illustrates a hyperspectral image of diesel fuel on carpet.

FIG. 21 illustrates a hyperspectral image of diesel fuel on carpet.

FIG. 22 illustrates a hyperspectral image of diesel fuel on carpet.

FIG. 23 is illustrative of fluorescence of gasoline on a glass slide imaged on top of black cotton.

FIG. 24 represents spectra of gasoline on AI plate and on white cotton.

FIG. 25 represents spectra of a white cotton substrate blank.

FIG. 26 represents spectra of gasoline and diesel fuel on carpet.

FIG. 27 represents spectra of a carpet substrate blank.

FIG. 28 represents spectra of gasoline and diesel fuel on carpet.

FIG. 29 represents spectra of a carpet substrate blank.

FIG. 30 represents spectra of gasoline on carpet and denim.

FIG. 31 represents spectra of gasoline on AI plate and carpet.

FIG. 32 represents spectra of diesel fuel on AI plate and carpet.

FIG. 33 represents gasoline on white cotton at various time intervals.

FIG. 34 represents gasoline of denim at various time intervals.

FIG. 35 represents diesel fuel on white cotton at various time intervals.

FIG. 36 represents multi-stain samples on various substrates.

FIG. 37 represents detection capabilities of the present disclosure for multi-stain samples.

FIG. 38 represents detection capabilities of the present disclosure for multi-stain samples.

FIG. 39 represents spectra of various substances.

FIG. 40 represents hyperspectral images of a blinded sample.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts.

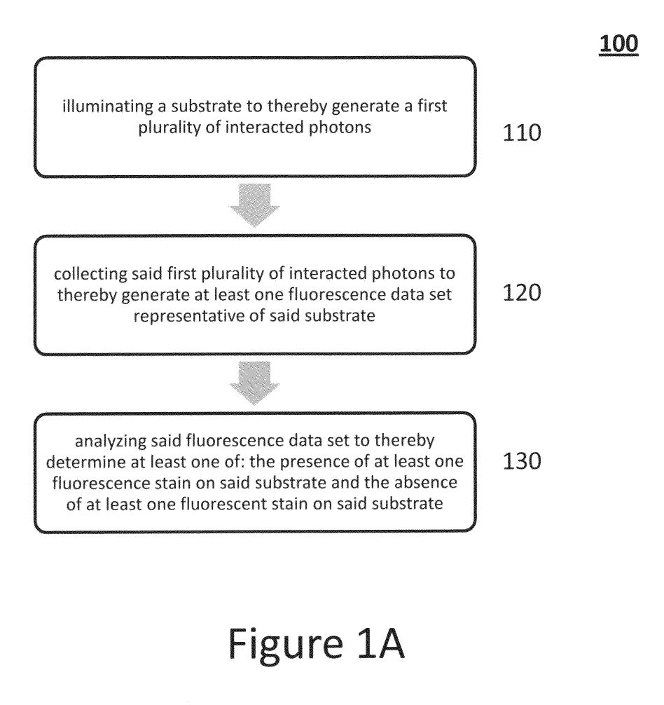

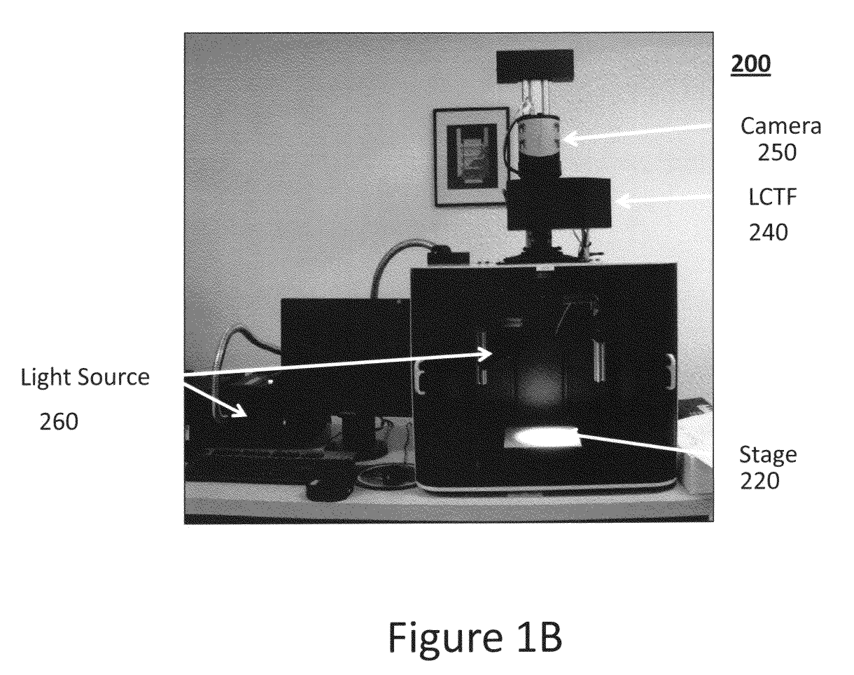

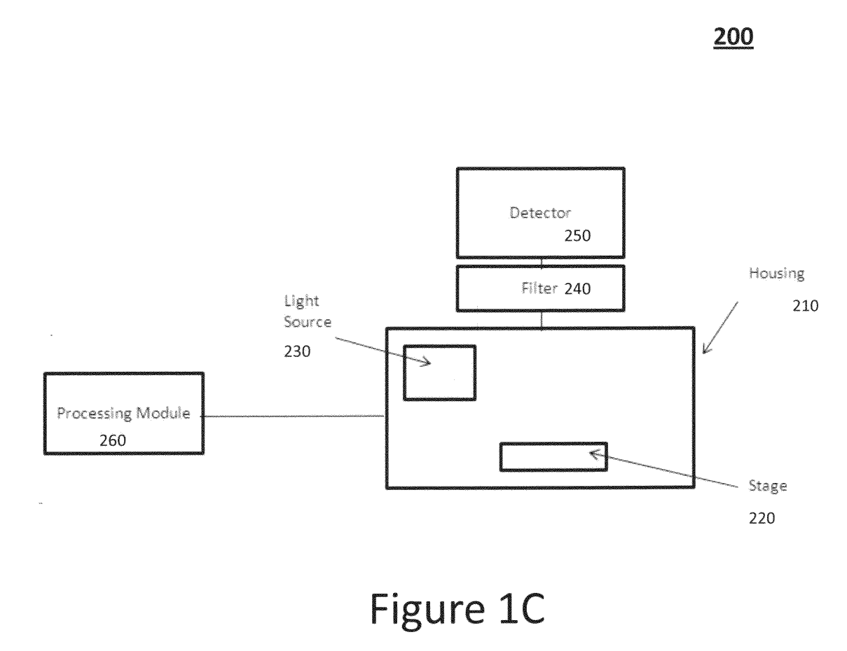

The present disclosure provides for a method for detecting fluorescence stains, which may be indicative of ILRs. In one embodiment, illustrated by FIG. 1A, the method 100 may comprise illuminating a substrate in step 110 to thereby generate a first plurality of interacted photons. In one embodiment, this first plurality of interacted photons may comprise photons selected from the group consisting of: photons absorbed by said substrate, photons reflected by said substrate, photons scattered by said substrate, photons emitted by said substrate, and combinations thereof. In step 120, a first plurality of interacted photons may be collected to thereby generate at least one fluorescence data set representative of said substrate. In one embodiment, a fluorescence data set may comprise at least one hyperspectral fluorescence image representative of said substrate. In another embodiment, a fluorescence data set may comprise at least one of: a fluorescence spectrum, a spatially accurate wavelength resolved fluorescence image, and combinations thereof.

In one embodiment, the method 100 may further comprise passing a first plurality of interacted photons through a tunable filter. A tunable filter may be configured so as to sequentially filter said first plurality of interacted photons into a plurality of predetermined wavelength bands.

In step 130, said fluorescence data set may be analyzed to thereby determine at least one of: the presence of at least one fluorescence stain and the absence of at least one fluorescence stain. In one embodiment, the analyzing of step 130 may further comprise identifying one or more regions of interest comprising at least one fluorescence stain. In the case of multiple fluorescence stains, these regions of interest may be located and the distribution of these stains may be analyzed. Location and distribution of fluorescence stains may convey information to a crime scene investigator about how the stains were deposited on the substrate. For example, a spatter pattern of many small stains may be indicative of one deposition method where as a one large stain may be indicative of another.

In one embodiment, a fluorescence stain may be associated with one or more unknown substances. In one embodiment, analyzing a fluorescence data set may further comprise comparing a fluorescence data set to a reference fluorescence data set, wherein said fluorescence data set corresponds to a know material. This known material may include a known ILR. In such an embodiment, data obtained from a fluorescence stain on an article of clothing, carpet, or other material may be compared to other evidence found in or around a crime scene. This other evidence may include ignitable liquids such as, but not limited to, gasoline, diesel fuel, lighter fluid, and combinations thereof.

In one embodiment, comparison of a fluorescence data set to a reference data set may be achieved by visual inspection. In another embodiment, comparison may be achieved by applying one or more chemometric techniques. This chemometric technique may comprise at least one of: partial least squares discriminate analysis, cosine correlation analysis, Euclidian distance analysis, k-means clustering, multivariate curve resolution, band t. entropy method, mahalanobis distance, adaptive subspace detector, spectral mixture resolution, Bayesian fusion, and combinations thereof.

In one embodiment, the method 100 may further comprise interrogating one or more regions of interest comprising fluorescence stains with at least one other technique. In one embodiment, at least one region of interest may be interrogated using Raman techniques such as Raman spectroscopy and/or Raman hyperspectral imaging. In another embodiment, at least one region of interest may be interrogated using gas chromatography-mass spectroscopy (GCMS). Such interrogation may provide for an identification of at least one unknown substance represented in the fluorescence stain. Therefore, such interrogation may enable the association of a fluorescence stain with at least one known ignitable liquid.

The present disclosure also provides for a system for detecting fluorescence stains on a substrate. Exemplary housing configurations of a system of the present disclosure 200 are illustrated in FIG. 1B. As illustrated in FIG. 1B, the system 200 may comprise at least one light source 260, a camera (detector) 250, a filter (LCTF) 240, and a stage for holding a substrate under analysis 220.

One embodiment of a system 200 is illustrated in FIG. 1C. In such an embodiment, the system 200 may comprise a housing 210 further comprising at least one light source 230 and a stage 220 configured for holding a substrate under analysis. The light source 260 may illuminate a substrate on a stage 220 and thereby generate a first plurality of interacted photons. The first plurality of interacted photons may pass through a filter 240. In one embodiment, a filter 240 may comprise a tunable filter. A tunable filter may select which wavelengths of light reach a detector. For a specific fluorescence example, if a sample absorbs light at 450 nm, and emits photons at 540 nm, it is the tunable filter which would allow only the 540 nm emission light to reach the detector at the 540 nm frame of the data collection. The tunable filter eliminates the need for the use of individual barrier filters which are typically used in fluorescence viewing. The contrast which is seen in the images is due to the fluorescence of the sample, which appears bright, on a background which appears darker due to a lack of fluorescence or fluorescence at a lesser intensity than the sample at a particular wavelength. Software which projects the digital image may be equipped with an auto-contrast function which may exaggerate intensity differences providing images with increased contrast. Auto-contrast functions by assigning the highest intensity value pixel to appear white, and the darkest intensity pixel to appear black. All intermediate pixel intensities appear as shades of grey.

In one embodiment, this tunable filter may be selected from the group consisting of: acousto-optic tunable filters, liquid crystal tunable filters, multi-conjugate liquid crystal tunable filters, and combinations thereof. In one embodiment, the tunable filter may comprise filter technology available from ChemImage Corporation, Pittsburgh, Pa. This filter technology may comprise that more fully described in the following U.S. patents and U.S. patent applications, hereby incorporated by reference in their entireties: U.S. Pat. No. 7,362,489, entitled “Multi-conjugate liquid crystal tunable filter” filed on Apr. 22, 2005, U.S. Pat. No. 6,992,809, also entitled “Multi-conjugate liquid crystal tunable filter”, filed on Feb. 2, 2005, Ser. No. 61/324,963, entitled “Short Wavelength Infrared (SWIR) Multi-Conjugate Liquid Crystal Based Tunable Filter,” filed on Apr. 16, 2010, and Ser. No. 61/403,141, entitled “Systems and Methods for Improving Imaging Technology,” filed on Sep. 10, 2010.

A tunable filter may be selected from the group consisting of: a multi-conjugate filter, a Fabry Perot angle tuned filter, an acousto-optic tunable filter, a liquid crystal tunable filter, a Lyot filter, an Evans split element liquid crystal tunable filter, a Solc liquid crystal tunable filter, a fixed wavelength Fabry Perot tunable filter, an air-tuned Fabry Perot tunable filter, a mechanically-tuned Fabry Perot tunable filter, and a liquid crystal Fabry Perot tunable filter, and combinations thereof.

In one embodiment, the system and method utilize ChemImage Multi-Conjugate Filter (“MCF”) technology available from ChemImage Corporation, Pittsburgh, Pa. A multi-conjugate filter, a type of liquid crystal tunable filter (LCTF), consists of a series of stages composed of polarizers, retarders and liquid crystals. The multi-conjugate filter is capable of providing diffraction limited spatial resolution, and a spectral resolution consistent with a single stage dispersive monochromator. A multi-conjugate filter may be computer controlled with no moving parts. It may be tuned to any wavelength in the given filter range. This results in an essentially infinite number of spectral bands available.

A tunable filter 240 may be configured so as to sequentially filter said first plurality of interacted photons into a plurality of predetermined wavelength bands. Interacted photons may be detected by a detector 250 to thereby generate at least one fluorescence data set representative of a substrate. In one embodiment a detector 250 may comprise a CCD detector. This CCD detector may comprise a 1024×1024 pixel CCD camera for image collection. In another embodiment, this detector 250 may further comprise a Si detector, a CMOS detector, and combinations thereof. In one embodiment, a processing module 260 may be operatively coupled to a system 200. This processing module may comprise a computer and/or other controls for operating the system 200 and displaying and analyzing images on a monitor. In one embodiment this processing module may comprise ChemImage Xpert™ version 2.5.2 software (ChemImage Corporation, Pittsburgh, Pa.) for controlling the system 200.

### Example

HSI analysis of ILRs was achieved using the CONDOR™ Macroscopic Hyperspectral Imaging System (ChemImage Corp, Pittsburgh Pa.). A Mini CrimeScope (MCS) 400 Series (SPEX, Edison, N.J.) was used for sample illumination. Tunable filter wheels included with the MCS offer specific illumination wavelengths at 300-400 nm, 415 nm, 445 nm, 455 nm, 515 nm, 535 nm, 555 nm, and 600 nm. The CONDOR is equipped with a tunable filter, which may comprise an LCTF and/or an MCF, which selects the wavelength of light allowed to reach the camera. A 1024×1024 pixel CCD camera (Princeton Instruments, Trenton, N.J.) is used for image collection with the CONDOR. The instrument was controlled with ChemImage Xpert™ version 2.5.2 software (ChemImage Corporation, Pittsburgh, Pa.)

For quality control purposes, tests may be performed to ensure spectral integrity, signal to noise ratio, system drift performance, light tightness, and image parfocality. These tests may be performed with standards provided by Labsphere® (North Sutton, N.H.). Standards used may be a 99% reflectance standard, a multicomponent standard, and a fluorescence standard.

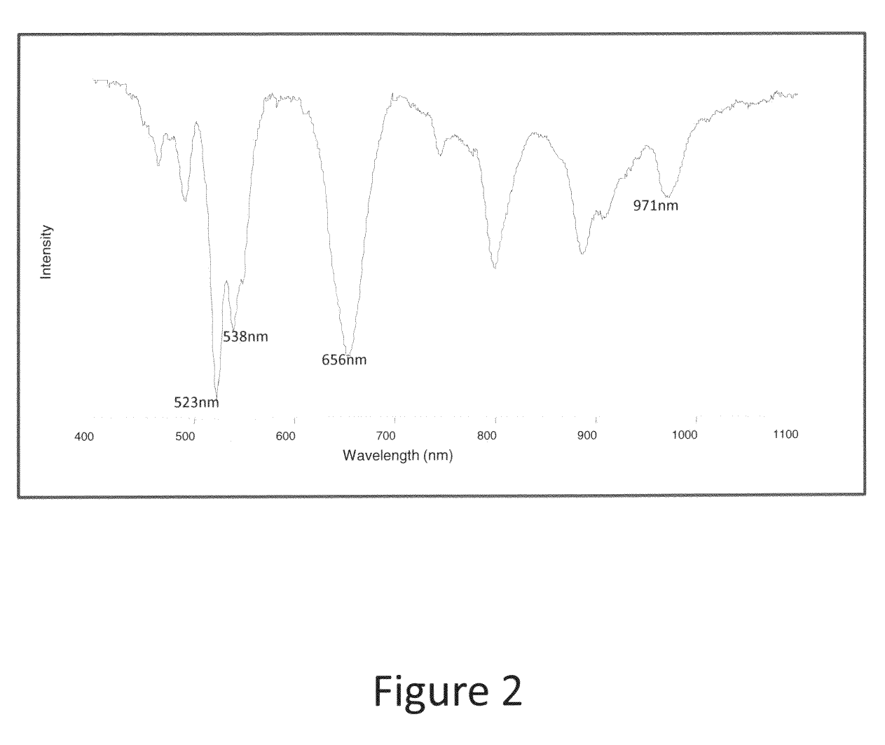

To measure spectral integrity, the spectrum of the multicomponent standard was divided by the spectrum of the 99% reflectance standard and the peak values in the resulting spectrum were compared to expected values given by Labsphere. FIG. 2 illustrates a resulting spectrum from dividing the spectrum of a multicomponent standard by the spectrum of the 99% reflectance standard. The labeled peaks are outlined in calibration requirements.

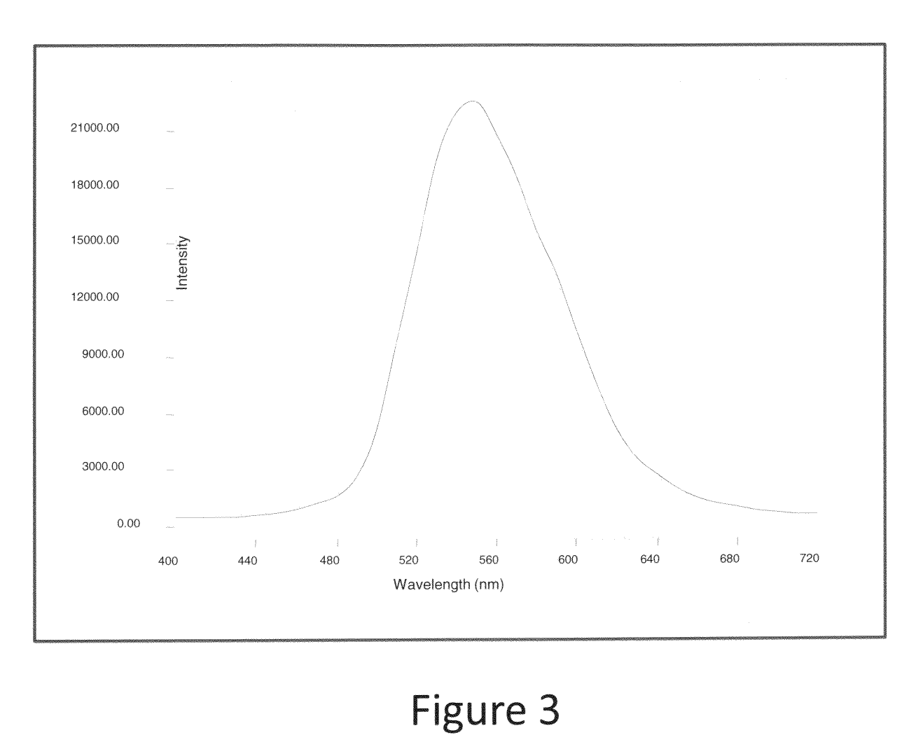

Peak values should be within 1 nm from the expected values. Signal to noise difference was measured by collecting a dataset of the fluorescence standard which should give an intensity peak at 540 nm when exposed to 300-400 nm illumination. In the spectrum of the fluorescence standard dataset (FIG. 3), with 300-400 nm illumination, the intensity peak at 540 nm is measured as well as the lack of fluorescence at 450 nm to represent the background. These two values are subtracted and the difference should be above 500 intensity units. System drift, light tightness, and image parfocality are measured based on numerical values and image quality. System drift is determined by collecting two datasets of the 99% reflectance standard under the exact same conditions for each, and then one is divided by the other. All pixels of the divided image are averaged and a mean intensity value is attained from the averaged image. The mean intensity value should be 1±10% to indicate that the system is robust. Light tightness is measured by turning off all source lights (i.e. the MCS and halogen lamp) and collecting an image of the 99% reflectance standard with the room lights on and one image with the room lights off. The minimum and maximum intensity values for each image are determined and the lights on values are subtracted by the lights off values; the difference should be less than 5 intensity counts/second. Parfocality is determined by focusing on an image at full zoom and then zooming out to minimum zoom and seeing if the image remains in focus throughout the transition.

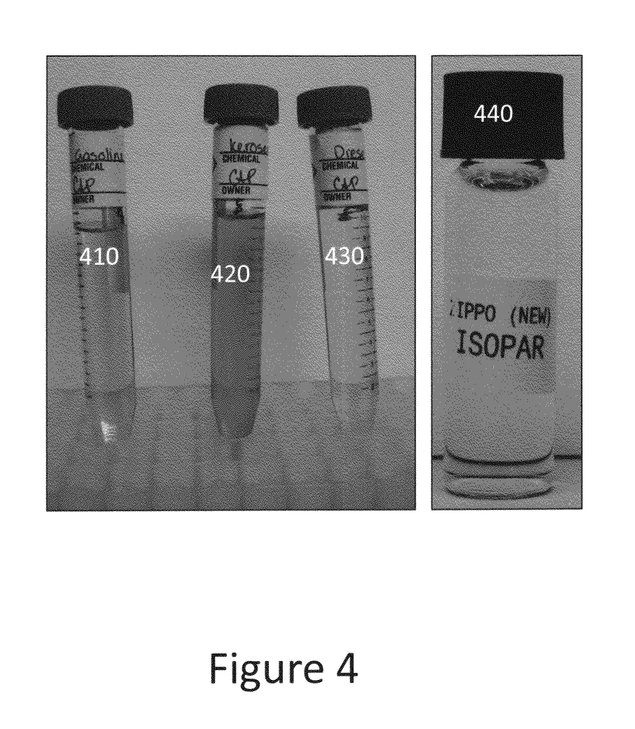

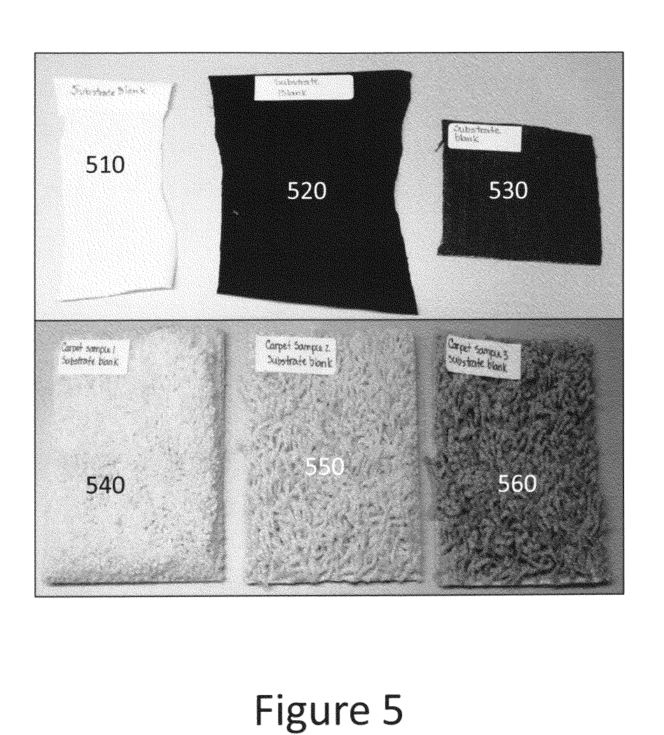

The present disclosure provides for the analysis of various ILRs. These may include but are not limited to: gasoline, kerosene, and diesel fuel, lighter fluid, and combinations thereof. These ignitable liquids are illustrated in FIG. 4. In the embodiment represented by FIG. 4, gasoline 410, kerosene 420, and diesel fuel 430 were all colored, and the lighter fluid 440 (Zippo) was undyed. The three dyed liquids were chosen because they are documented as the three most commonly used in arson cases. The undyed lighter fluid was chosen to act as a negative control as it was an undyed petroleum product. The gasoline, kerosene, and diesel fuel were purchased at local gas stations, the lighter fluid was a sample provided by the crime lab. The substrates used, illustrated in FIG. 5, were white cotton cut from a white cotton t-shirt 510 (Hanes, ComfortSoft), black cotton cut from a black cotton t-shirt 520 (Jerzees), and denim cut from a pair of shorts 530 (Levi's). Three types of carpet were also used as substrates, also illustrated in FIG. 5. These substrates include Carpet 1 540 (Shaw brand, Inspired Touch style, Mirage color), Carpet 2 550 (Shaw brand, Alpine style, Moonlight color), and Carpet 3 560, (Shaw brand, Alpine style, Arrowhead color). All three carpet samples were from Home Depot. Fabrics and carpets are relevant substrates to be examined as they were cited in a study as being a highly submitted evidence type, second only to ashen debris, in the arson cases from one year at a forensic laboratory.

All data was collected in the form of fluorescence hyperspectral images. Before any sample data was collected, the liquids were allowed to evaporate from the substrate for at least 24 hours. First, the optimal illumination wavelengths for the ignitable liquid samples were determined. As previously listed, the MCS comes with filters allowing illumination in the wavelengths of 300-400 nm, 415 nm, 445 nm, 455 nm, 515 nm, 535 nm, 555 nm, and 600 nm. To determine the wavelengths which would result in the highest intensity fluorescent images for each ignitable liquid, images were collected for each illumination wavelength option and mean intensity values were acquired. The collection range for each illumination wavelength can be seen in (Table 1), these remain constant for all following data collection. For the illumination wavelength determination, the ignitable liquids were imaged on a nonfluorescent background, specifically an aluminum plate.

TABLE 1

| Illumination λ | | Collection Range |
|---|---|---|
| 300-400 | nm | 420 nm-720 nm @ 10 nm steps |
| 415 | nm | 450 nm-720 nm @ 10 nm steps |
| 445 | nm | 480 nm-720 nm @ 10 nm steps |
| 455 | nm | 510 nm-720 nm @ 10 nm steps |
| 515 | nm | 550 nm-720 nm @ 10 nm steps |
| 535 | nm | 600 nm-720 nm @ 10 nm steps |
| 555 | nm | 620 nm-720 nm @ 10 nm steps |
| 600 | nm | 650 nm-720 nm @ 10 nm steps |

After the optimal illumination wavelengths for each liquid were determined, the experimental design continued in three levels. Before any sample data was collected, a substrate blank dataset for each substrate was collected at the illumination wavelengths used in the experimentation. To attain the mean intensity value for each substrate blank, each dataset was averaged and a region of interest (ROI) which included all pixels was selected and the mean intensity value was given for that chosen ROI. The collection parameters used for this data collection are listed in (Table 2). As seen in (Table 2), there are several camera settings which remained constant throughout data collection, those being binning, averages, and speed and gain; these settings are typical to almost all data collection done with the CONDOR.

TABLE 2

| | |
|---|---|
| Binning | 1 × 1 |
| Averages | 1 |
| Exposure Time | 30 seconds/60 seconds |
| Speed/Gain | Hi/Hi |
| ROI Coordinates | Left = 323, Right = 843, |
| | Top = 238, Bottom = 735 |
| | (variable) |

The exposure time setting was adjusted from 30 seconds to 60 seconds for samples which did not fluoresce strongly and needed a longer exposure time. The ROI coordinates listed are pixel coordinates which mark the area within the 1024×1024 field of view that was used during data collection. In order to decrease data collection time, the full field of view was cropped so that only the area on the substrate which contained the ILRs was imaged. The ROI coordinates are listed as variable because the area selected changed slightly for some of the samples collected due to sample size.

In the first level of experimentation, the lower limit of detection (LLOD) was determined by collecting datasets of decreasing volumes and dilutions of each liquid on each substrate. The decreasing volumes examined were 20 μL, 10 μL, 5 μL, 2 μL, and 1 μL. The dilutions examined were 1:2, 1:5, 1:10, 1:25, and 1:30. Dilutions were mixed with water since water would logically be the liquid that would most commonly come into contact with the ILR stains either in the process of fire suppression, or in washing. Since the ignitable liquids are not water soluble, the dilution samples were shaken by hand and immediately pipetted onto the substrate before the water and hydrocarbon layers separated. Also as part of the LLOD testing, duration samples were examined to determine the amount of time after deposition that a stain could still be imaged on each substrate. 20 μL aliquots of sample were examined for the duration samples. Durations samples were made with gasoline on both white cotton and denim substrate, and also diesel fuel on white cotton. The duration samples were made in triplicate and datasets were collected weekly. Samples were kept in unsealed plastic bags and exposed to room lighting, at room temperature. The collection parameters for data collection were the same as listed in (Table 2), with the exception of denim which required a longer exposure time of 60 seconds.

Processing steps were applied to the LLOD datasets in order to eliminate spectral interference from the substrate background and also to improve image contrast between the ILR and the background by filtering noise. The first processing step applied was background division. This was performed by manually selecting an ROI in the image which consisted only of pixels which represent the substrate. The spectrum associated with this ROI was representative of the background. Background division diminishes this spectrum's influence from the overall spectrum which represents all the pixels of the image. Once the background was divided out, an ROI selected within the visualized ILR was more representative of that ILR's fluorescence without the background contribution. To some samples, normalization was applied in order to accentuate the image of the stain on the substrate background. Normalization is a technique which corrects for the influence of image topography by scaling the spectral data to the same intensity scale. Additionally a reduce noise filter was applied to some of the images in order to improve image contrast.

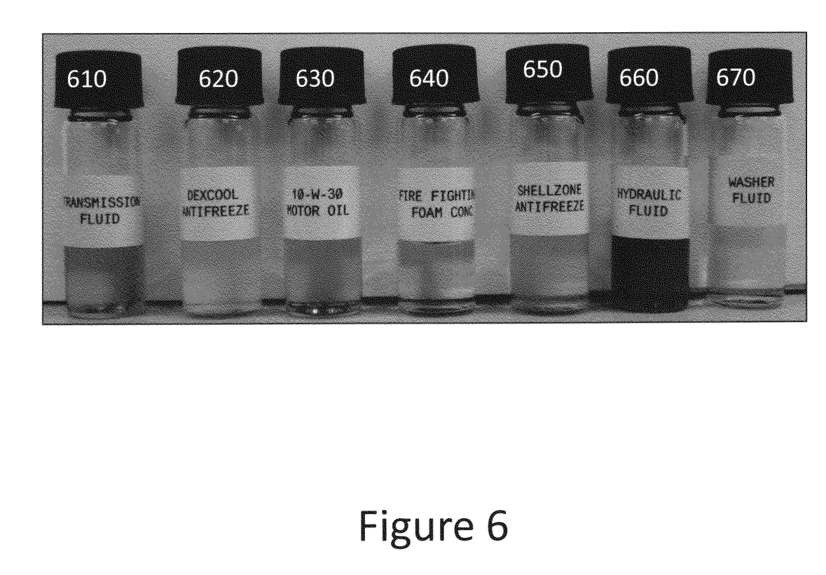

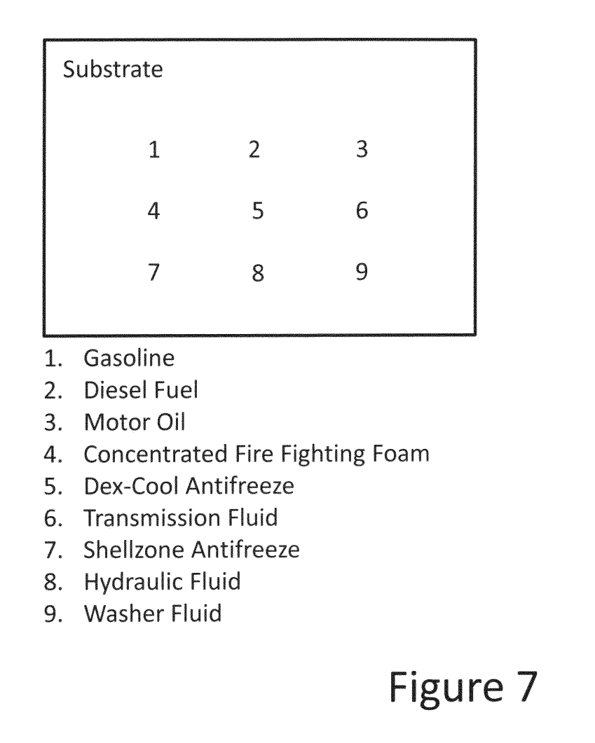

The second level of experimentation involved multi-stain samples to determine the specificity of the HSI method. The liquids used for these samples, illustrated by FIG. 6, were washer fluid 670, hydraulic fluid 660, two different antifreezes 620 and 650, motor oil 630, and transmission fluid 610. Also looked at was concentrated fire fighting foam 640. These particular liquids were chosen because they are obviously colored with dyes which may fluoresce similarly to the dyes found in ignitable liquids. The firefighting foam in particular is an advantageous sample for comparison since in all likelihood it would be found at many arson scenes, and would therefore be expected to be on carpet especially. To make the multi-stain samples, 10 μL of each of the dyed liquids along with 10 μL of each gasoline and diesel fuel were pipetted onto white cotton, denim, and a swatch of carpet 1. The designation of each of the fluids can be seen in FIG. 7. All multi-stain samples were allowed to dry over a weekend before any data was collected. Data was collected for these samples using the same parameters and illumination as listed in Table 2, with the only difference being a larger field of view. Data was processed similarly to the LLOD data using background division and normalization.

The third level of experimentation was examination of blinded samples which mimicked real world evidentiary samples. The purpose of these tests was to determine the amount of time required for real world application, and also the success of visualizing all stains present, and the ability of HSI to distinguish stains of different compositions. Blinded sample datasets were collected using the same parameters as was used for the LLOD and multi-stain samples. An additional processing step of principal component analysis (PCA) was used when analyzing the blind samples as a means of visualizing stains which were not revealed with the normalization and reduce filter processing. PCA is a multivariate statistical method of analysis which emphasizes discrete differences in sample data (Jolliffe). PCA can also be used as a method of indicating which stains are similar and which ones are of a different chemical makeup. PCA works by categorizing data groupings which are most similar and continuing through data points which are not as strongly associated. The noise in the image is mostly shown in the last frames of the PC score images, and the relevant data is seen in the earlier frames.

Before any sample data collection was performed to determine the illumination wavelengths which would result in the highest intensity fluorescent images for the liquid samples, a substrate blank dataset of the A1 plate was collected at each illumination wavelength to ensure that there would not be any interference from the background. Mean intensity values for the A1 blank are listed in Table 3. There was not any significant fluorescence contribution from the A1 at any of the illumination wavelengths.

TABLE 3

| Illumination λ | | Mean Intensity |
|---|---|---|
| 300-400 | nm | 593 |
| 415 | nm | 594 |
| 445 | nm | 593 |
| 455 | nm | 594 |
| 515 | nm | 595 |
| 535 | nm | 593 |
| 555 | nm | 593 |
| 600 | nm | 597 |

For each sample dataset, four ROIs were selected in the stain and a mean intensity range was documented. An additional ROI was selected of just the A1 and a signal to noise ratio was determined by averaging the intensities of the four sample ROIs and dividing the sample intensity value by the background intensity value. The intensity values and signal/noise ratios for each liquid at each illumination wavelength are listed in Tables 4-7.

In Table 4, Mean intensity and signal/noise ratio for gasoline on the A1 plate. The highlighted rows emphasize that the 445 nm and 455 nm filters produced the strongest intensity and highest signal/noise ratio.

TABLE 4

| | | Mean Intensity | Background | |
|---|---|---|---|---|
| Illumination λ | | Range | Intensity | Signal/Noise |
| 300-400 | nm | 1177-1241 | 508 | 2.37 |
| 415 | nm | 1153-1320 | 530 | 2.33 |
| 445 | nm | 2728-6994 | 538 | 9.03 |
| 455 | nm | 4714-11,116 | 584 | 13.55 |
| 515 | nm | 2419-5093 | 527 | 7.12 |
| 535 | nm | 1576-3980 | 515 | 5.39 |
| 555 | nm | 804-1374 | 508 | 2.14 |
| 600 | nm | 600-799 | 510 | 1.37 |

In Table 5 Mean intensity and signal/noise ratio for diesel fuel on the A1 plate. The highlighted rows emphasize that the 445 nm and 455 nm filters produced the strongest intensity and highest signal/noise ratio.

TABLE 5

| | | Mean Intensity | Background | |
|---|---|---|---|---|
| Illumination λ | | Range | Intensity | Signal/Noise |
| 300-400 | nm | 994-2043 | 551 | 2.75 |
| 415 | nm | 995-2118 | 562 | 2.76 |
| 445 | nm | 1637-4619 | 587 | 5.32 |
| 455 | nm | 2098-6550 | 634 | 6.82 |
| 515 | nm | 1131-2593 | 570 | 3.26 |
| 535 | nm | 580-1735 | 580 | 1.99 |
| 555 | nm | 655-959 | 548 | 1.47 |
| 600 | nm | 651-786 | 600 | 1.19 |

In Table 6, Mean intensity and signal/noise ratio for kerosene on the A1 plate. None of the illumination wavelength filters produced a significant fluorescent signal.

TABLE 6

| | | Mean Intensity | Background | |
|---|---|---|---|---|
| Illumination λ | | Range | Intensity | Signal/Noise |
| 300-400 | nm | 612-638 | 539 | 1.15 |
| 415 | nm | 522-549 | 490 | 1.09 |
| 445 | nm | 517-568 | 487 | 1.11 |
| 455 | nm | 571-611 | 495 | 1.19 |
| 515 | nm | 614-718 | 497 | 1.34 |
| 535 | nm | 621-705 | 490 | 1.35 |
| 555 | nm | 542-582 | 485 | 1.15 |
| 600 | nm | 956-704 | 584 | 1.42 |

In Table 7, Mean intensity and signal/noise ratio for undyed lighter fluid on the A1 plate. None of the illumination wavelength filters produced a significant fluorescent signal.

TABLE 7

| | | Mean Intensity | Background | |
|---|---|---|---|---|
| Illumination λ | | Range | Intensity | Signal/Noise |
| 300-400 | nm | 516-518 | 524 | .98 |
| 415 | nm | 511-513 | 519 | .98 |
| 445 | nm | 520-532 | 528 | .99 |
| 455 | nm | 550-556 | 560 | .98 |
| 515 | nm | 518-528 | 602 | .86 |
| 535 | nm | 510-514 | 528 | .96 |
| 555 | nm | 497-502 | 508 | .98 |
| 600 | nm | 550-558 | 664 | .83 |

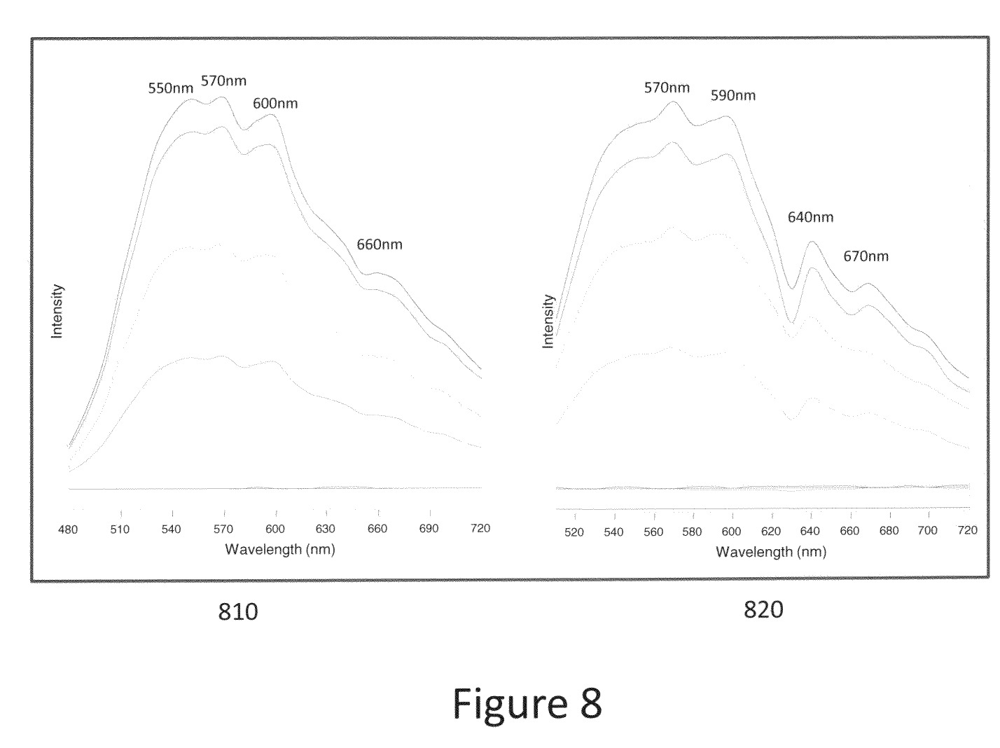

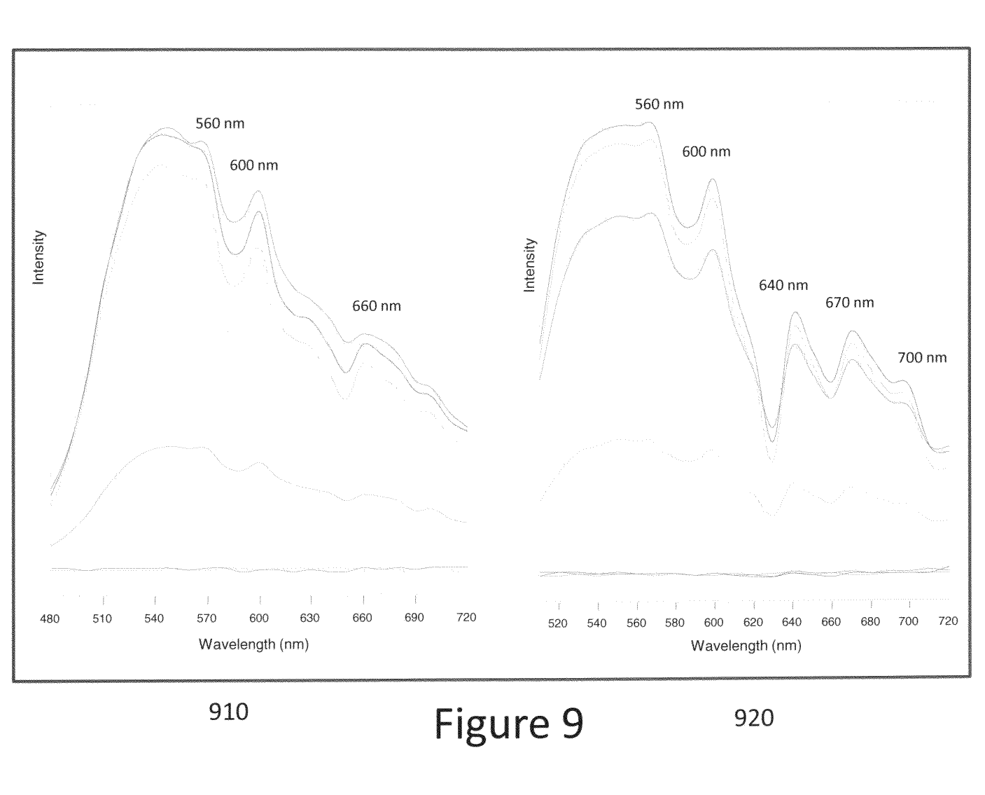

As can be seen in Tables 4 and 5, the illumination wavelengths which resulted in the highest intensity for both gasoline and diesel fuel were 445 nm and 455 nm. As the wavelengths 445 nm and 455 nm resulted in the highest intensity fluorescence, they are the two wavelengths of illumination which were used in all following data collection of gasoline and diesel fuel on the various substrates. The spectra for each gasoline and diesel fuel at both 445 nm and 455 nm are shown in FIGS. 8 and 9. In FIG. 8, 810 illustrates divided spectra of gasoline on AI plate at 445 nm illumination. Background divided spectra of gasoline on AI plate at 455 nm illumination is illustrated in 820. In FIG. 9, background divided spectra of diesel fuel on A1 plate at 445 nm illumination is illustrated in 910 and background divided spectra of diesel fuel on A1 plate at 455 nm illumination is illustrated in 920.

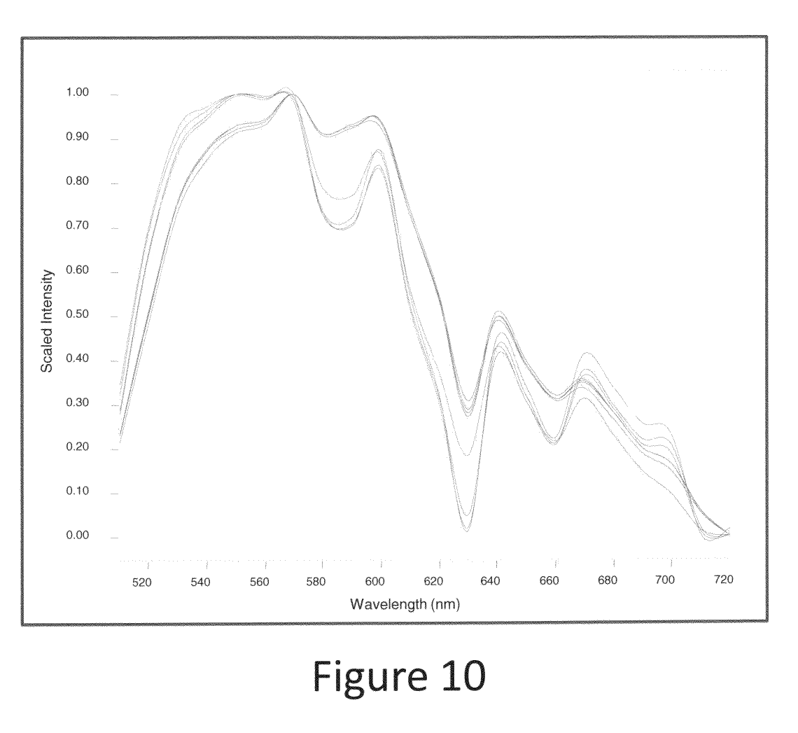

FIG. 10 illustrates the comparison spectra between gasoline and diesel fuel. FIG. 10 illustrates both gasoline (red grouping) and diesel fuel (blue grouping) spectra, background divided, with 455 nm illumination. The two liquid residues share multiple spectral peaks. The similarity between the spectrum for gasoline and the spectrum for diesel fuel may be due to both of them containing similar dyes, which is possible considering that they both share a yellow visual appearance.

As can be seen in Table 6, kerosene did not fluoresce significantly under any wavelength of illumination as all signal to noise ratio values are roughly 1. Since the dyes and markers used in this sample of kerosene seemed to not be fluorescent, the kerosene sample was excluded from all further data collection. The sample of undyed lighter fluid also did not show any significant fluorescence under any of the illumination wavelengths Table 7. The lack of fluorescence in the lighter fluid however was expected as that sample was void of any dyes and markers which might result in a fluorescent response.

The substrate blank mean intensity values for all substrates at 445 nm and 455 nm illumination are listed in Table 8. Table 8 illustrates mean intensity values of each substrate with 445 nm and 455 nm illumination. It should be noted that the white cotton sample, as well as carpets 2 and 3 exhibited fluorescence mean intensity values in the thousands; the implications of this will be discussed later.

TABLE 8

| | 445 nm illumination | 455 nm illumination |
|---|---|---|
| Substrate | mean intensity | mean intensity |
| White Cotton | 2020 | 3512 |
| Black Cotton | 448 | 487 |
| Denim | 543 | 580 |
| Carpet 1 | 677 | 677 |
| Carpet 2 | 3119 | 12,334 |
| Carpet 3 | 3304 | 11,116 |

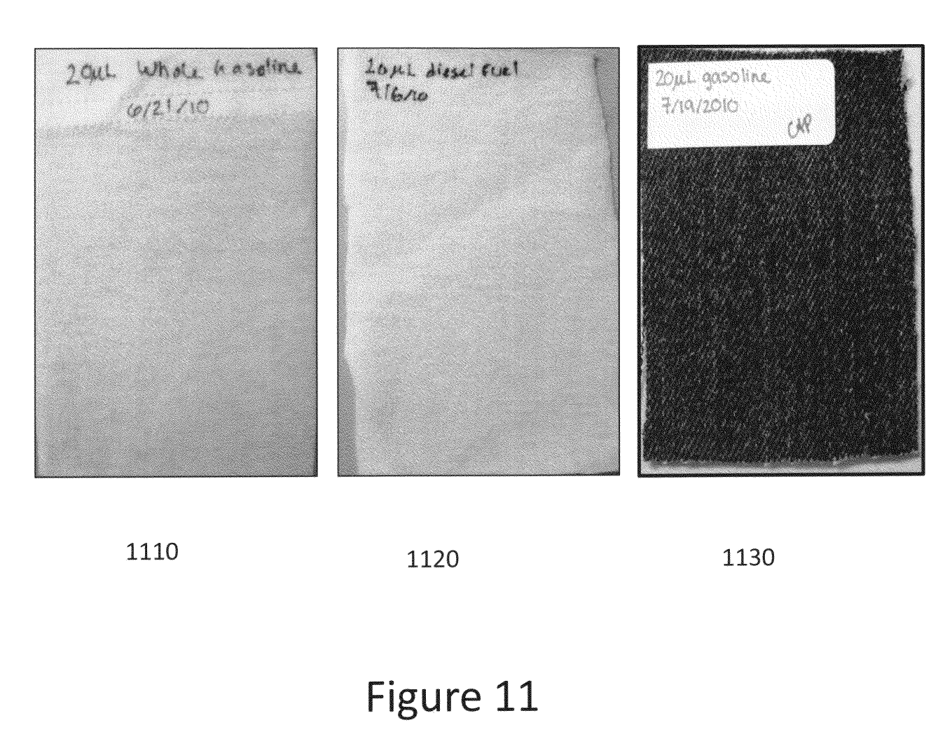

Gasoline and diesel fuel were both successfully visualized on white cotton, and carpets 1-3. Gasoline only was visualized on denim. Digital images of ILR sample on each substrate which was successfully visualized can be seen in FIGS. 11-13. FIG. 11 illustrates digital images of fabric substrates with sample of 20 μL gasoline on white cotton 1110, 20 μL diesel fuel on white cotton 1120, and 20 μL gasoline on denim 1130.

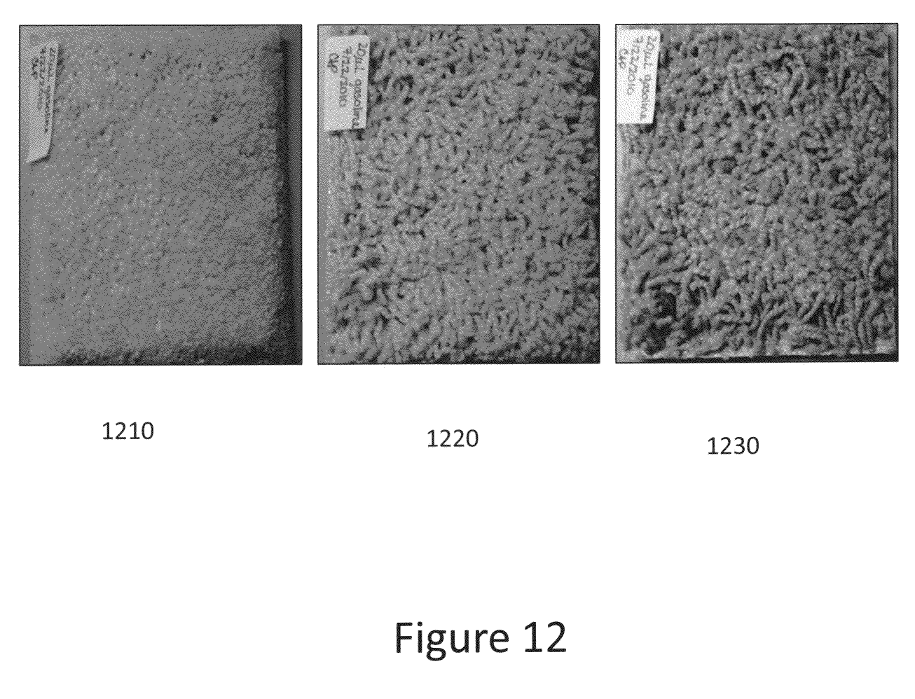

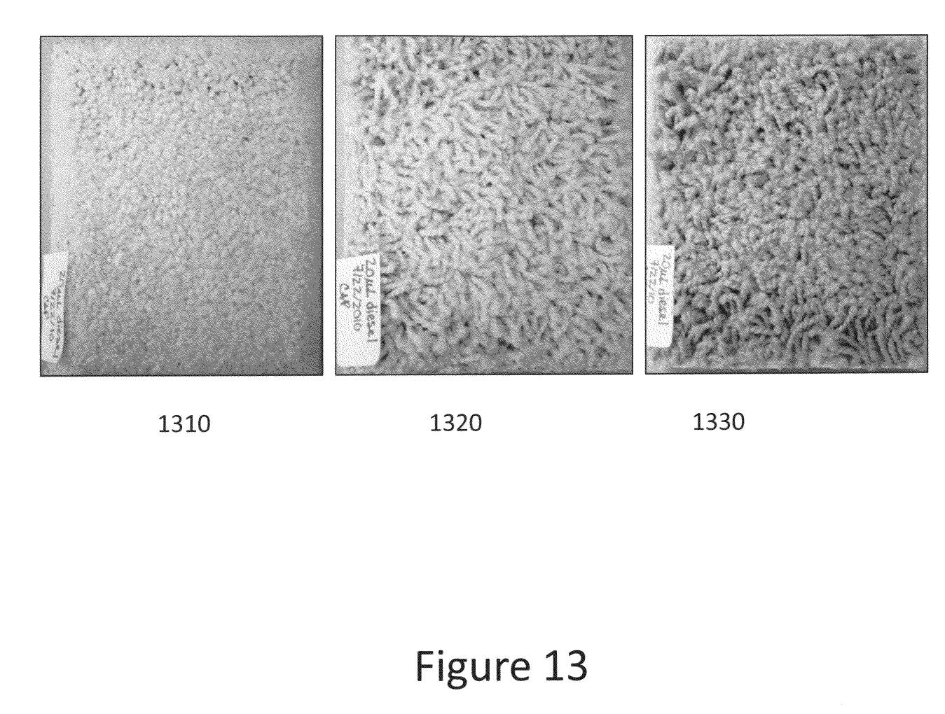

FIG. 12 illustrates digital images of carpet substrates with 20 μL gasoline samples from: carpet 1 1210, carpet 2 1220, carpet 3 1230. FIG. 13 illustrates digital images with carpet substrates with 20 μL diesel fuel sample from: carpet 1 1310, carpet 2 1320, and carpet 3 1330.

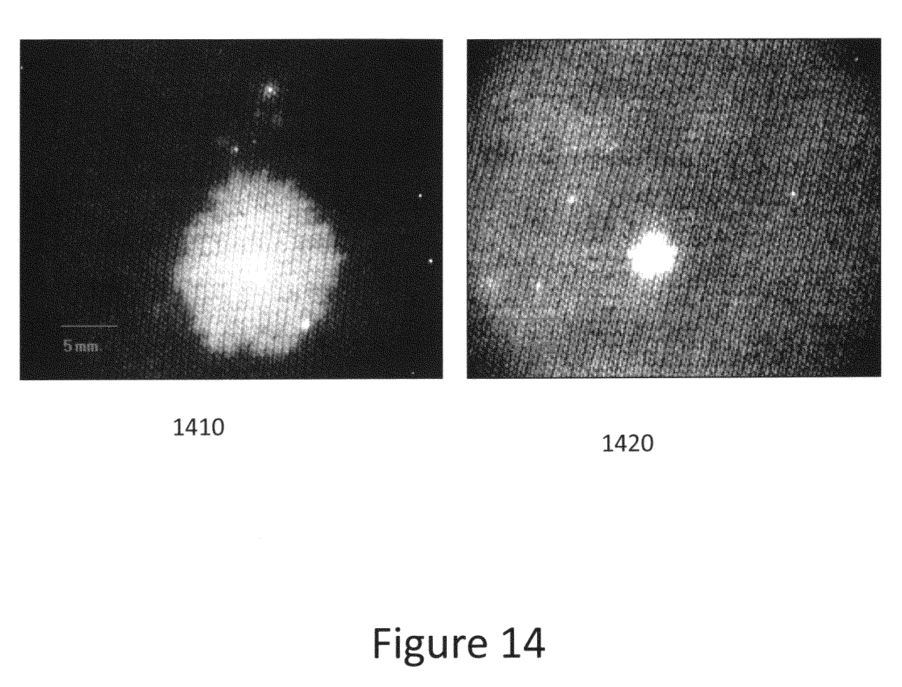

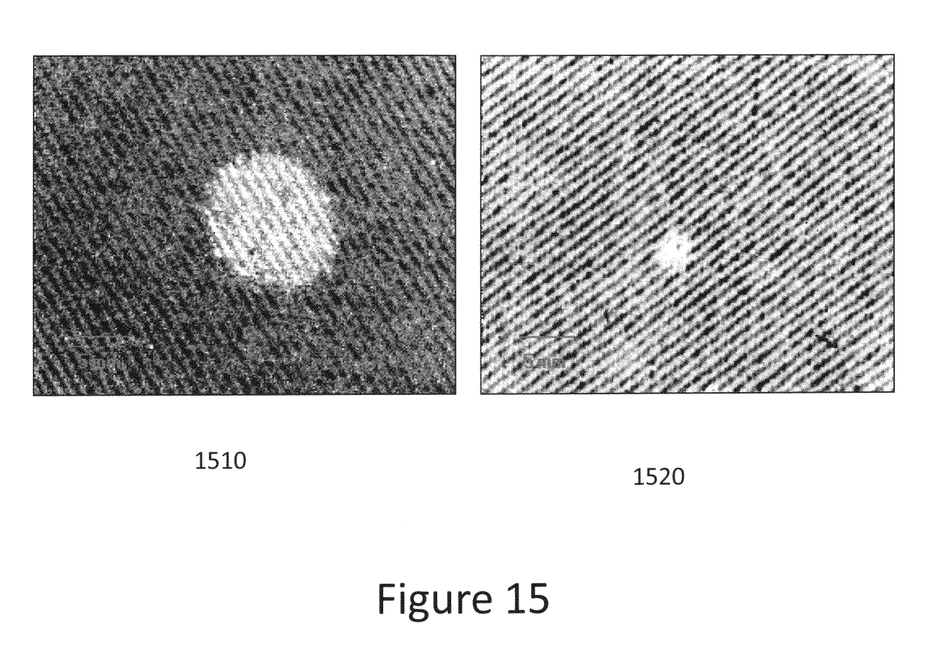

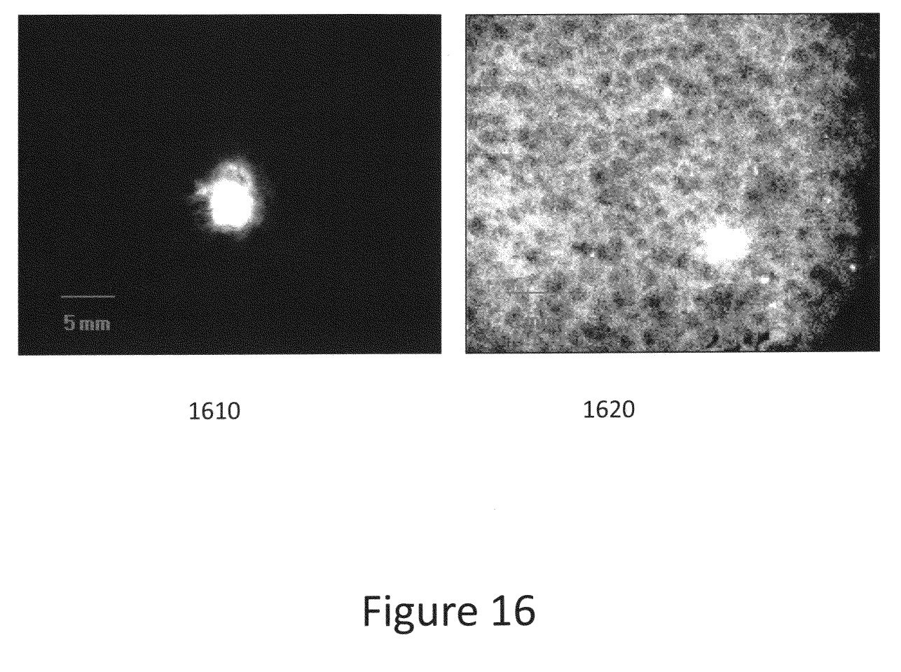

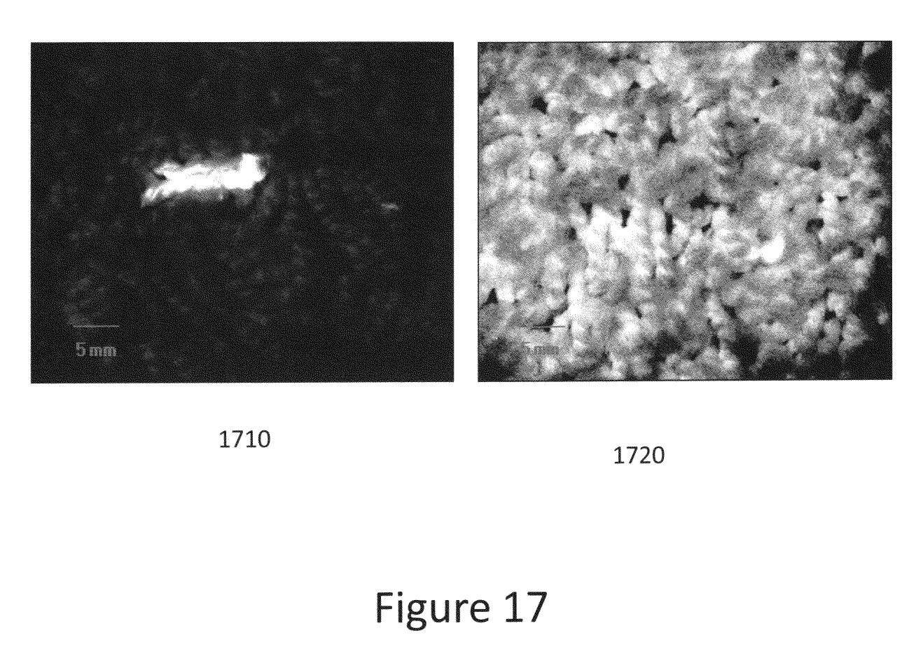

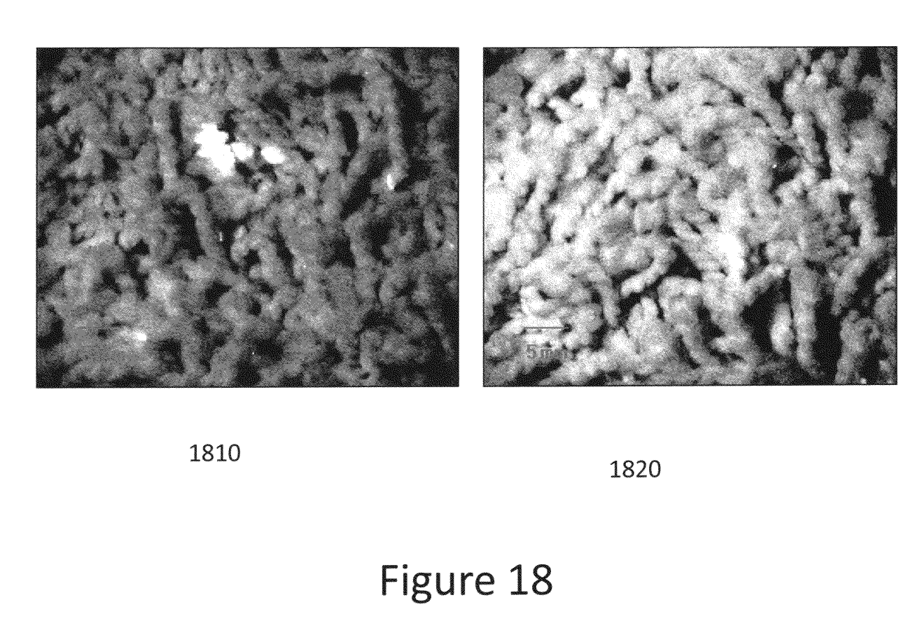

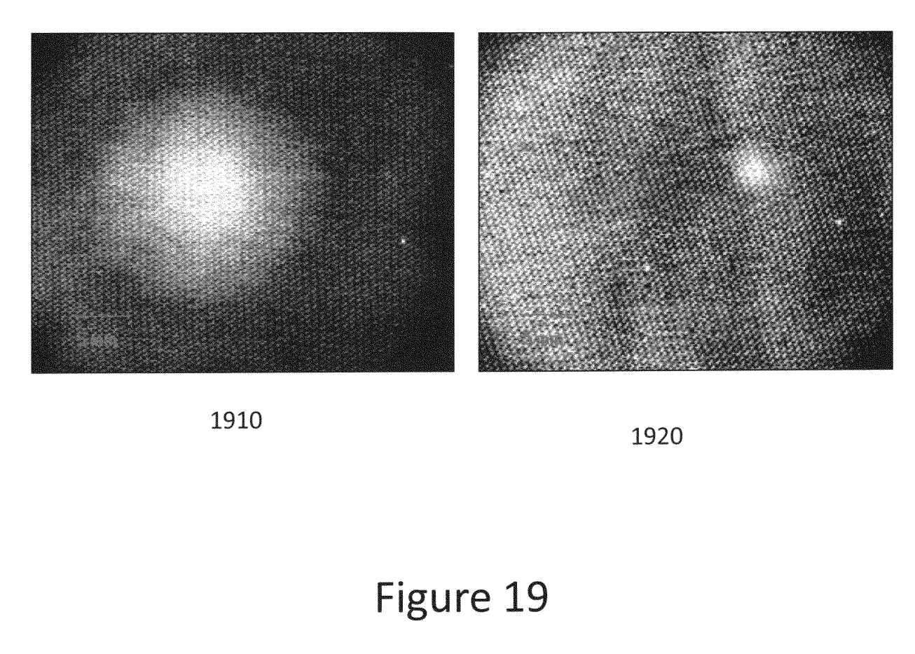

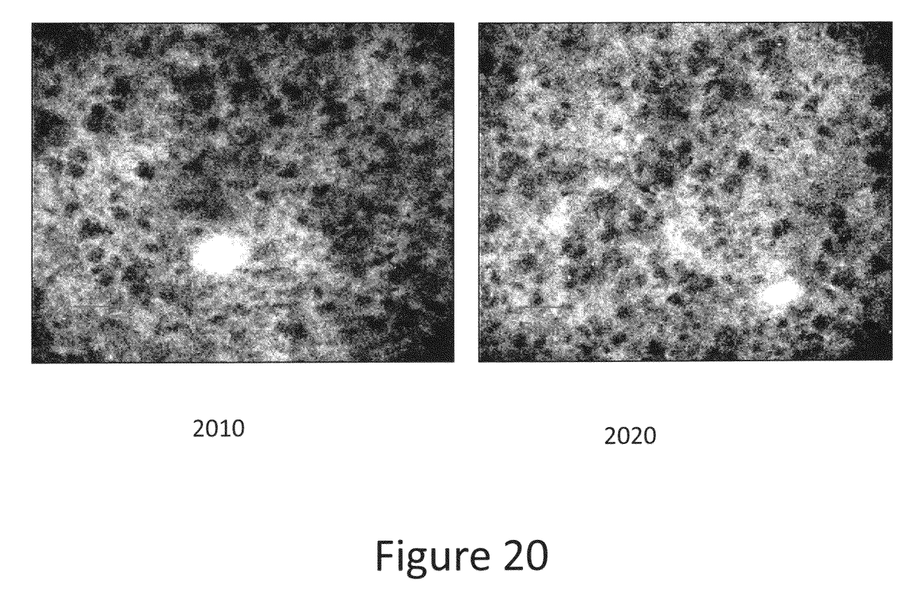

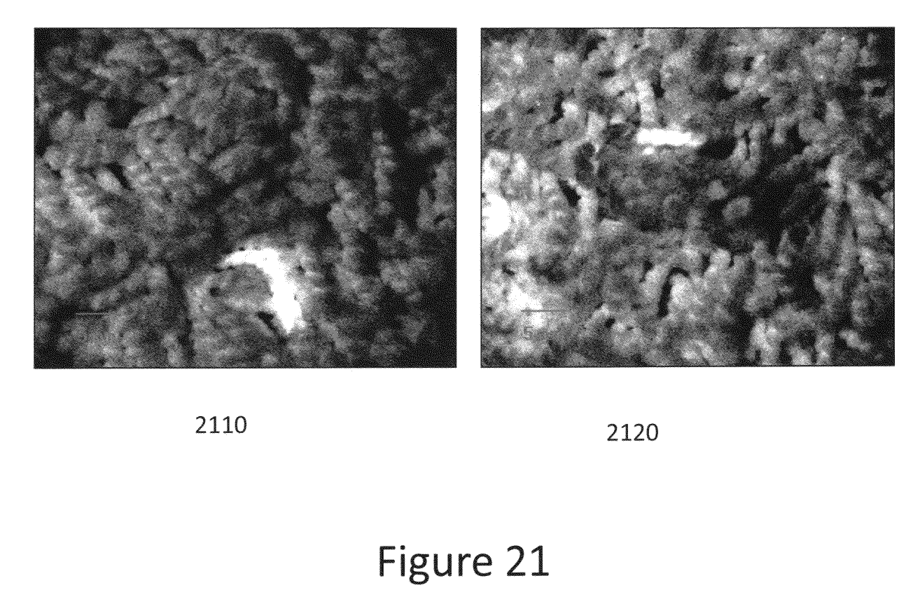

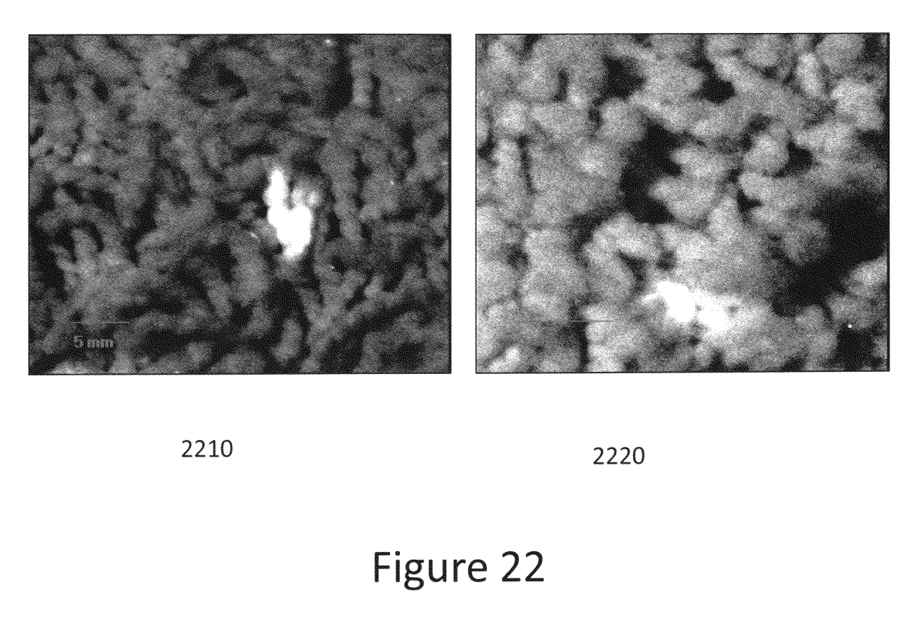

HSI images of the visualized ILRs can be seen in FIGS. 14-22. FIG. 14 illustrates 20 μL gasoline 1410 and 1 μL gasoline 1420 on white cotton at 455 nm illumination, 600 nm frame. Images were background divided. FIG. 15 illustrates 20 μL gasoline 1510 and 1 μL gasoline 1520 on denim at 445 nm illumination, 510 nm frame. Images were background divided, normalized, and reduce noise filter applied. FIG. 16 illustrates 20 μL gasoline 1610 and 1 μL gasoline 1620 on carpet 1 at 455 nm illumination, 540 nm frame. Images were background divided. FIG. 17 illustrates 20 μL gasoline 1710 and 1 μL gasoline 1720 on carpet 2 at 455 nm illumination, 540 nm frame. Images were background divided. FIG. 18 illustrates 20 μL gasoline 1810 and 1 μL gasoline 1820 on carpet 3 at 455 nm illumination, 540 nm frame. Images were background divided. FIG. 19 illustrates 20 μL diesel fuel 1919 and 1 μL diesel fuel 1920 on white cotton at 455 nm illumination, 570 nm frame. Images were background divided. FIG. 20 20 illustrates 20 μL diesel fuel 2010 and 1 μL diesel fuel 2020 on carpet 1 at 455 nm illumination, 540 nm frame. Images were background divided. FIG. 21 illustrates 20 μL diesel fuel 2110 and 10 μL diesel fuel 2120 on carpet 2 at 455 nm illumination, 540 nm frame. Images were background divided. FIG. 22 illustrates 20 μL diesel fuel 2210 and 2 μL diesel fuel 2220 on carpet 3 at 455 nm illumination, 540 nm frame. Images were background divided.

The smallest volumes and highest dilutions of gasoline and diesel fuel visualized on each substrate are listed in Tables 9A and 9B.

TABLE 9A
Gasoline Fluorescence-Results of LLOD Tests

| Substrate | Smallest Volume | Highest Dilution |
|---|---|---|
| White Cotton | 1 μL | 1:10 |
| Black Cotton | X | X |
| Denim | 1 μL | X |
| Carpet 1 | 1 μL | 1:10 |
| Carpet 2 | 1 μL | X |
| Carpet 3 | 1 μL | X |

TABLE 9B
Diesel Fuel Fluorescence-Results of LLOD Tests

| Substrate | Smallest Volume | Highest Dilution |
|---|---|---|
| White Cotton | 1 μL | 1:30 |
| Black Cotton | X | X |
| Denim | X | X |
| Carpet 1 | 1 μL | 1:30 |
| Carpet 2 | 10 μL | 1:2 |
| Carpet 3 | 2 μL | 1:2 |

1 μL volumes of gasoline were visualized on white cotton, denim, and all three carpet samples. When imaging the denim samples, it was discovered that better images were acquired when the denim substrate was flipped over to the back, because of this, all denim data was collected from the back of the denim swatches. It is thought that better images were attained from the back of the denim because the front side of denim has more variation in darkness and coloring, as opposed to the back which is more uniform. Gasoline dilutions up to 1:10 were visible on both white cotton and carpet 1. No gasoline was visualized on black cotton, and no gasoline dilutions were visualized on denim or carpets 2 and 3.

Diesel fuel volumes as small as 1 μL were visualized on white cotton as well as on carpet 1. The 10 μL diesel fuel stain was visualized on carpet 2 and 5 μL on carpet 3. On white cotton and carpet 1, the 1:30 diesel fuel dilution was successfully visualized, as well as the 1:2 diesel fuel dilution on carpets 2 and 3.

As was indicated, neither gasoline nor diesel fuel was able to be visualized on the black cotton substrate. An explanation offered for this lack of fluorescence involves the substrate type. When the liquids were deposited onto cotton, the liquid wicked into the fabric instead of remaining in a concentrated drop. Due to the wicking, the small amount of sample became dispersed into the substrate. It is reported that when another dye is added to a fluorescent solution, if one of the dyes absorbs the wavelength of light that the other emits, the fluorescence can be diminished. Since the appearance of black is due to the absorbance of all visible wavelengths, it is possible that the black dyes in the cotton absorbed or blocked the fluorescent emission of the gasoline before it reached the detector. This explanation is especially applicable since the sample would be largely dispersed in the fabric and therefore there would not be a concentrated area from which the fluorescence would be strongly emitted.

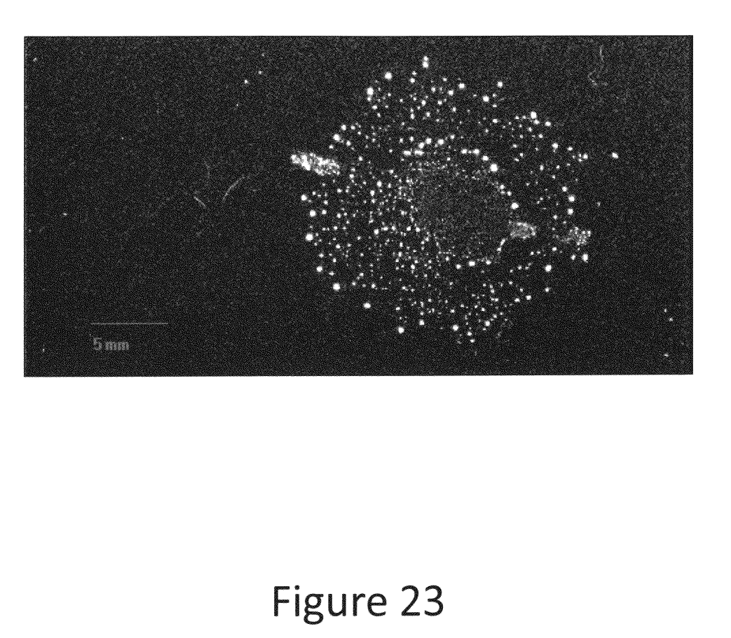

In an attempt to portray that the lack of fluorescence seen on the black cotton was due to an interaction of the ignitable liquids with the substrate fabric and dyes, 5 μL it of gasoline was deposited onto a glass slide and data was collected of the slide on top of the black fabric. As can be seen in FIG. 23 (455 nm illumination, 540 nm frame), when the gasoline is not permitted to wick into the fabric, the fluorescence can be captured in the image. The fluorescence seen when the gasoline is on top of the black fabric indicates that the fluorescence is diminished due to its interaction with the black fabric itself.

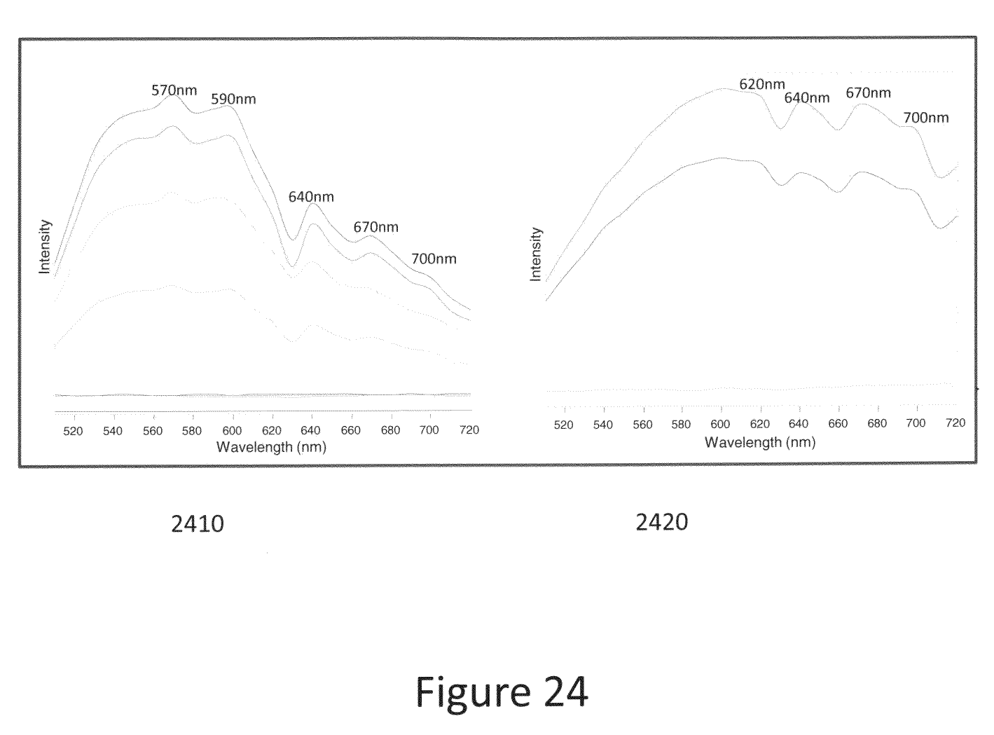

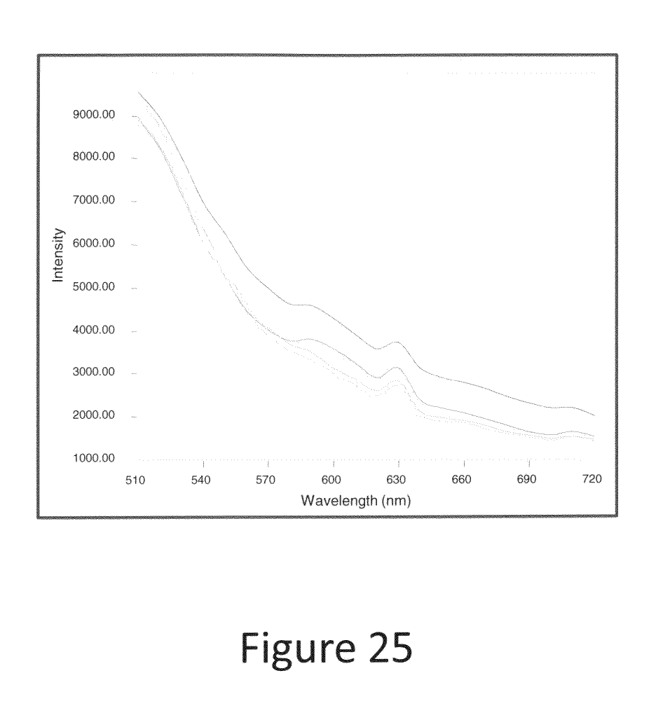

As mentioned before, the white cotton, carpet 2 and carpet 3 emitted mean intensity values in the thousands. FIG. 24 illustrates spectra of gasoline on A1 plate with 455 nm illumination 2410 and spectra of gasoline on white cotton with 455 nm illumination 2420. Both spectra have been background divided shows both the spectrum from gasoline on the A1 plate and the spectrum from gasoline on the white cotton, after background division. As can be seen, even though there are several peaks of the same wavelength values, overall the two spectra do not appear similar. FIG. 25 illustrates spectra of white cotton substrate blank with 455 nm illumination. FIG. 25 shows the spectrum collected from the white cotton substrate blank. As can be seen, the white cotton blank has its peak fluorescence intensity at the beginning of the data collection range at 510 nm.

It can be seen in FIG. 24 that the variation seen between the gasoline spectrum on A1 and the gasoline spectrum on white cotton is at the beginning of the collection range. It is thought that when the background division processing step was applied to the white cotton sample data, the result of dividing out the strong intensity of the cotton in the 510-600 nm range is also causing the 570 nm and 590 nm peaks that are seen in the gasoline spectrum from the A1 slide to be diminished in the gasoline on white cotton. A similar peak adjustment is present also in the spectrum of diesel fuel on white cotton.

It can be seen in FIG. 24 that the peaks seen in the spectrum from the gasoline on the A1 plate at 640 nm, 670 nm, and 700 nm are still present in the spectrum collected from the gasoline on the cotton; this is likely due to the cotton's decreased fluorescence at the end of the collection range causing less interference.

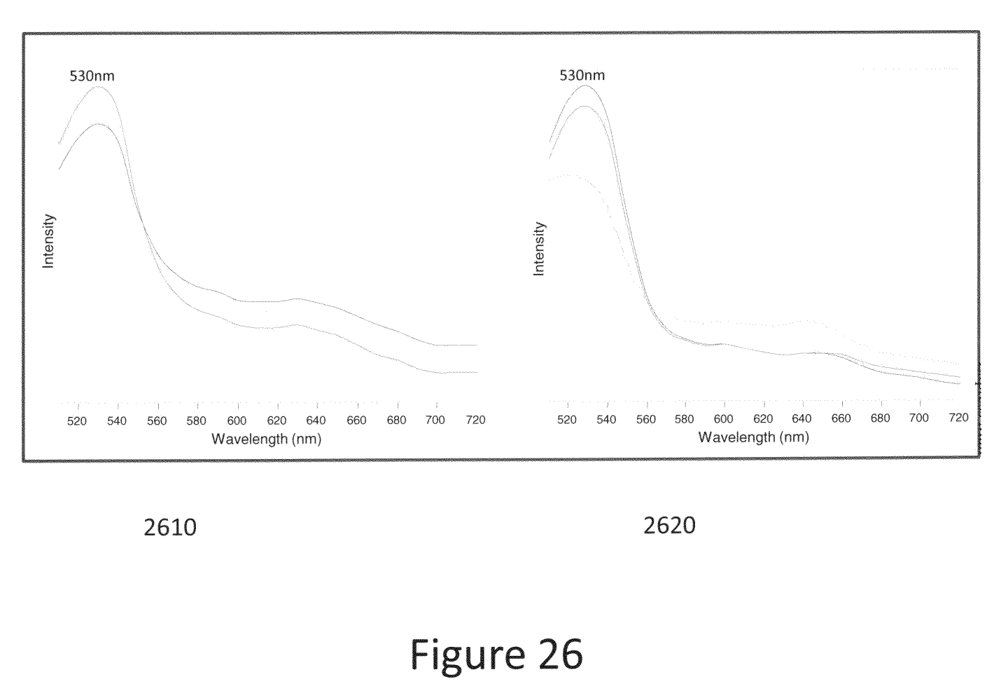

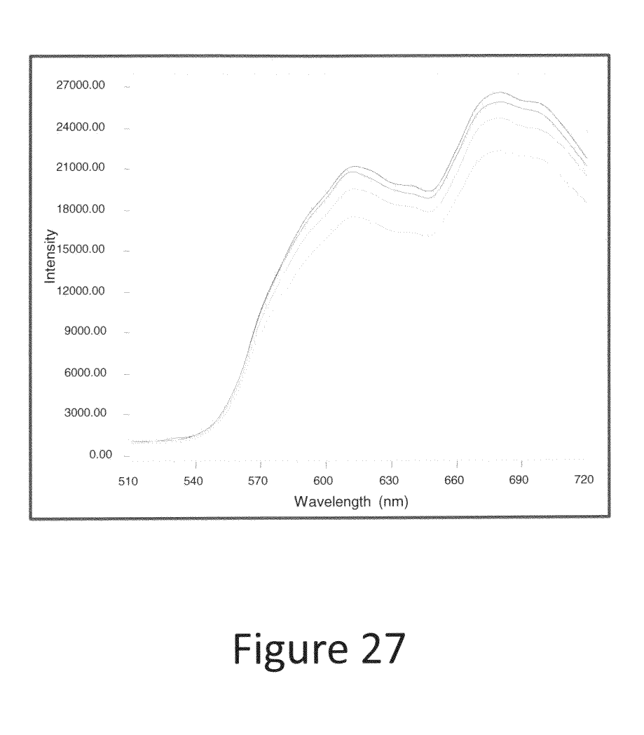

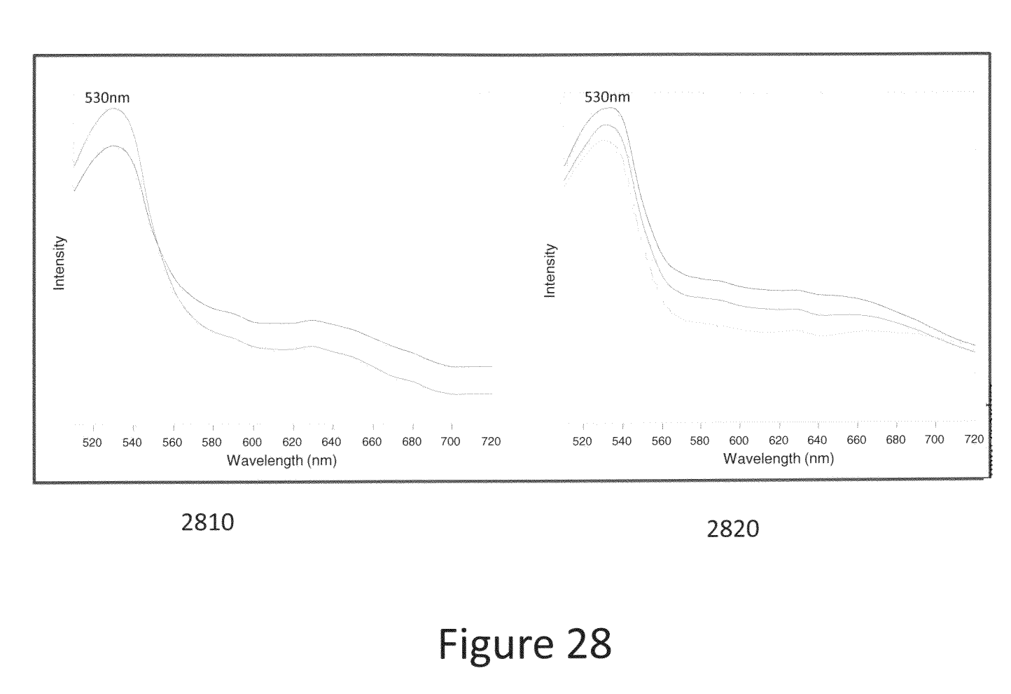

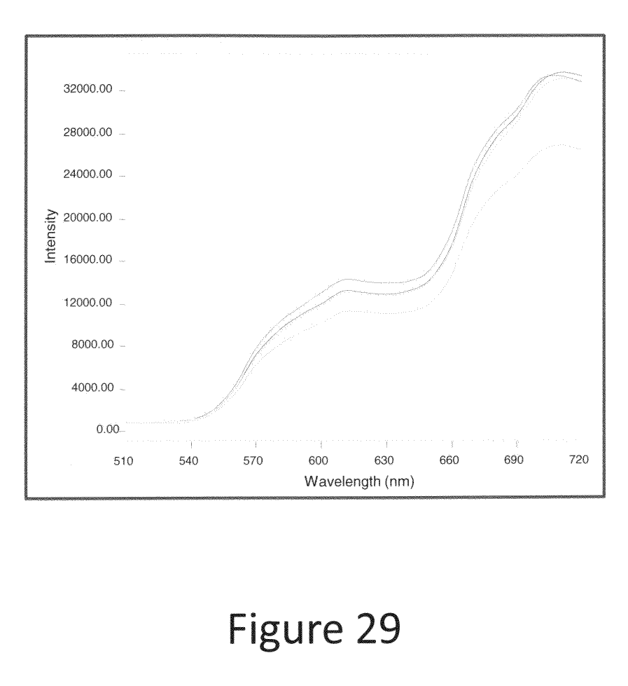

Similar spectral variations can be seen in the spectra of gasoline and diesel fuel on carpets 2 and 3, illustrated by FIGS. 26-29. FIG. 26 illustrates spectrum of gasoline on carpet 2 with 455 nm illumination 2610 and spectrum of diesel fuel on carpet 2 with 455 nm illumination 2620. Both spectra have been background divided. FIG. 27 illustrates spectra of carpet 2 substrate blank with 455 nm illumination. FIG. 28 illustrates spectra of gasoline on carpet 3 with 455 nm illumination 2810 and spectrum of diesel fuel on carpet 3 with 455 nm illumination 2820. Both spectra have been background divided. FIG. 29 illustrates spectra of carpet 3 substrate blank with 455 nm illumination.

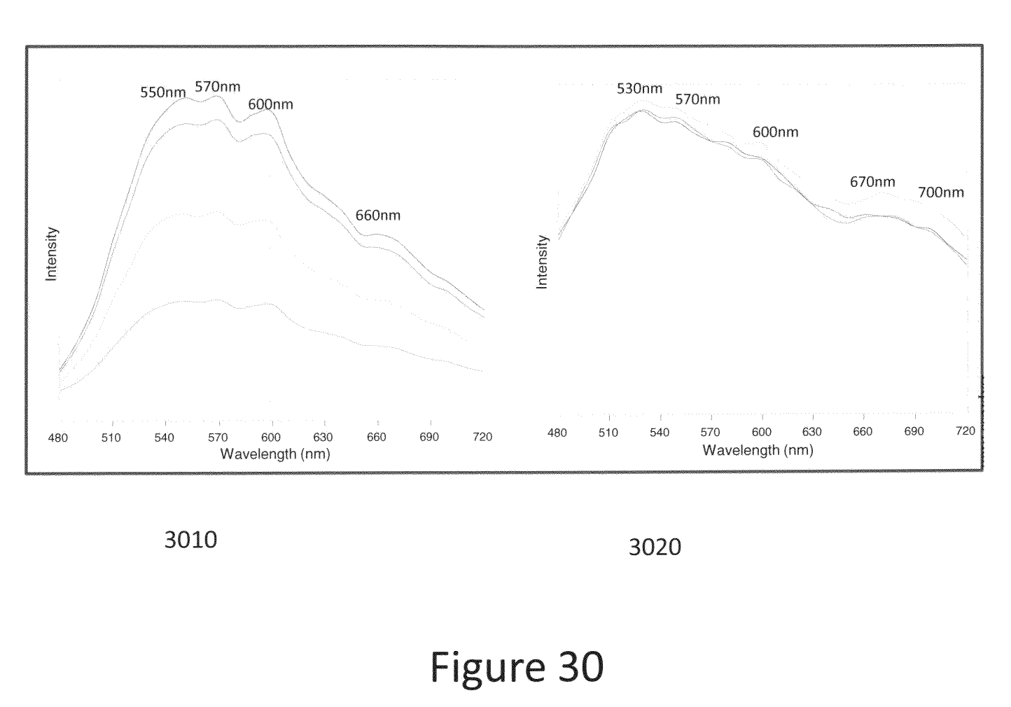

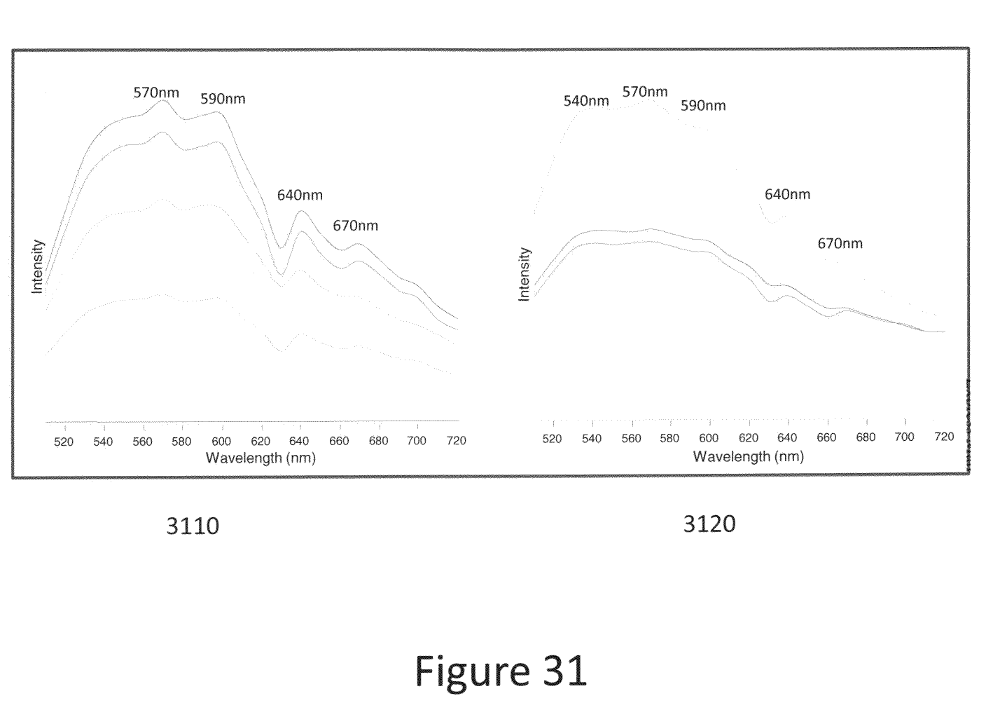

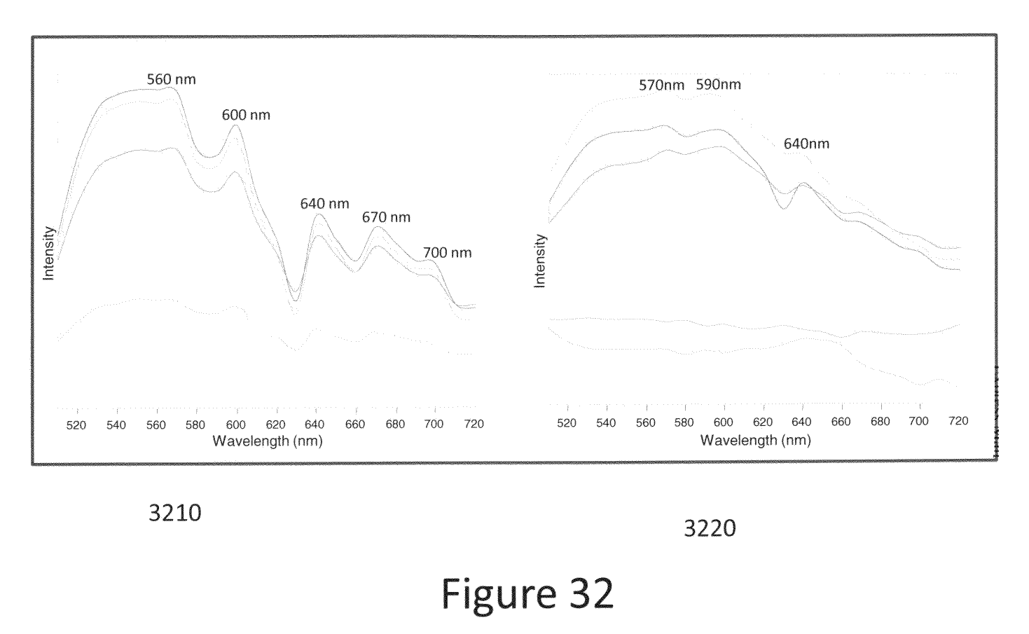

FIG. 30 illustrates spectra of gasoline on carpet A1 plate with 445 nm illumination 3010 and spectrum of gasoline on denim with 445 nm illumination 3020. Both spectra have been background divided. FIG. 31 illustrates spectra of gasoline on A1 plate with 455 nm illumination 3110 and spectra of gasoline on carpet 1 with 455 nm illumination 3120. Both spectra have been background divided. FIG. 32 illustrates spectra of diesel fuel on A1 plate with 455 nm illumination 3210 spectra of diesel fuel on carpet 1 with 455 nm illumination 3220. Both spectra have been background divided.

The spectra of gasoline on the denim and carpet 1, and the spectrum of diesel fuel on carpet 1 do not show the drastic spectral alteration that is seen on the more fluorescent backgrounds (FIGS. 30-32).

With the carpet samples however, the spectra of the ILRs is altered at the end of the collection range, this is because the peak fluorescence intensity of the carpet samples is towards the end of the collection range.

It should be noted that with the denim, the spectral peaks even though still present, are less pronounced than in what is seen with the gasoline on the A1 plate. The less pronounced peaks on the denim might be due to the substrate absorbing a portion of the gasoline emission causing a decrease in intensity. The denim absorption could also explain the lack of visualization of the diesel fuel on denim, especially since diesel's fluorescence intensity was less than gasoline's.

Overall it should be noted that the ILR spectral data collected seems to be influenced by the substrate onto which it is deposited. This caveat enforces that HSI should be used as a complimentary tool to be used with another method which would further confirm the presence of a specific ignitable liquid. HSI could be helpful with comparisons if a sample of ignitable liquid is found at the scene. The comparison liquid could be deposited onto a substrate material similar to the substrate which contained stains to determine if the fluorescence from the unknown stains is similar to that of the known ignitable liquid.

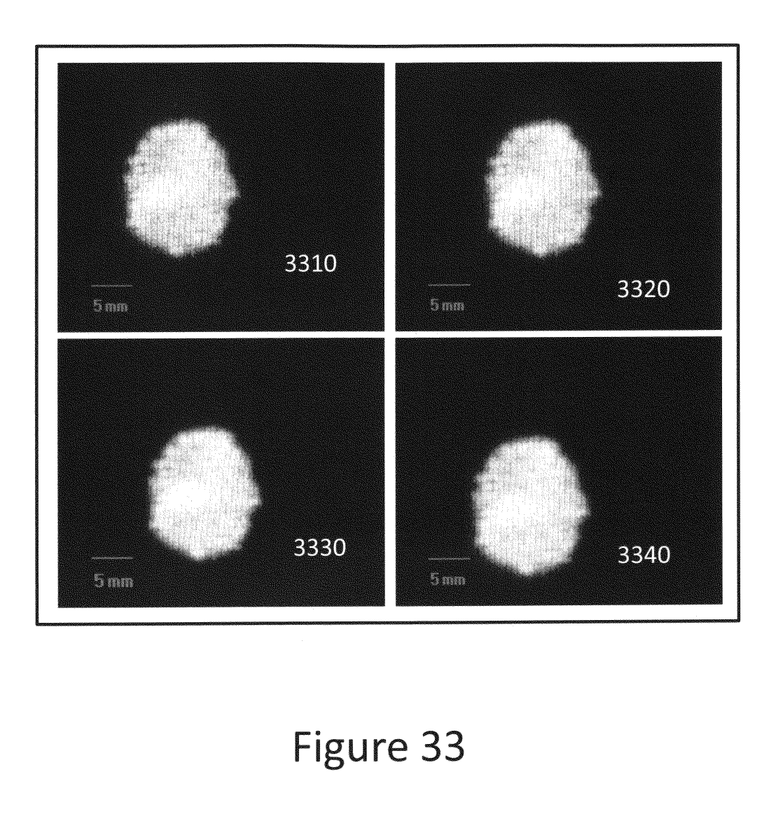

Sample duration after deposition was also studied. Images were successfully acquired with all duration samples at 4 weeks after deposition. Images of each sample at weekly intervals can be seen in (FIGS. 33-35).

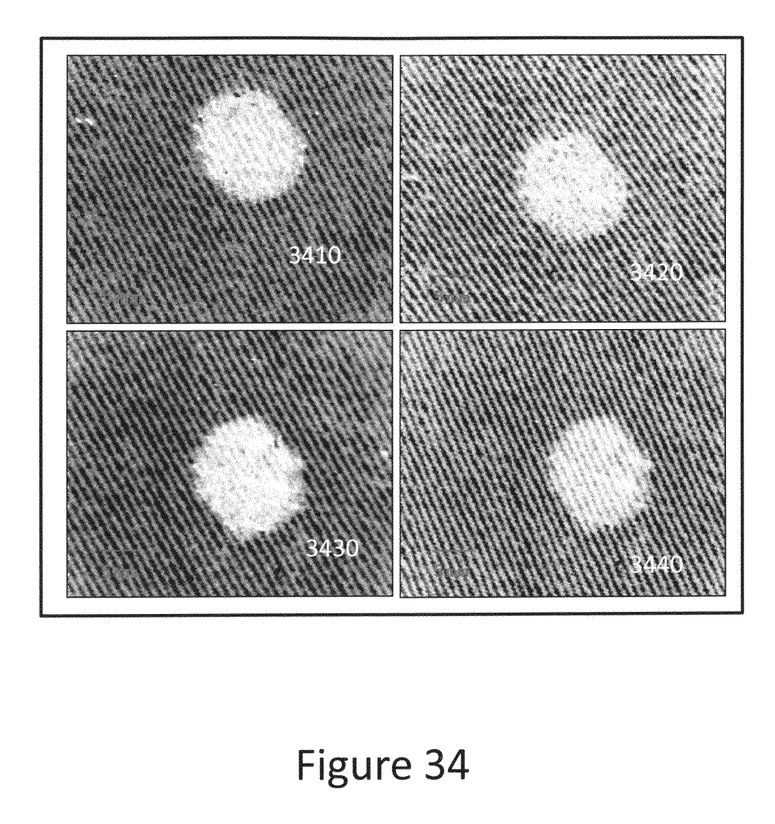

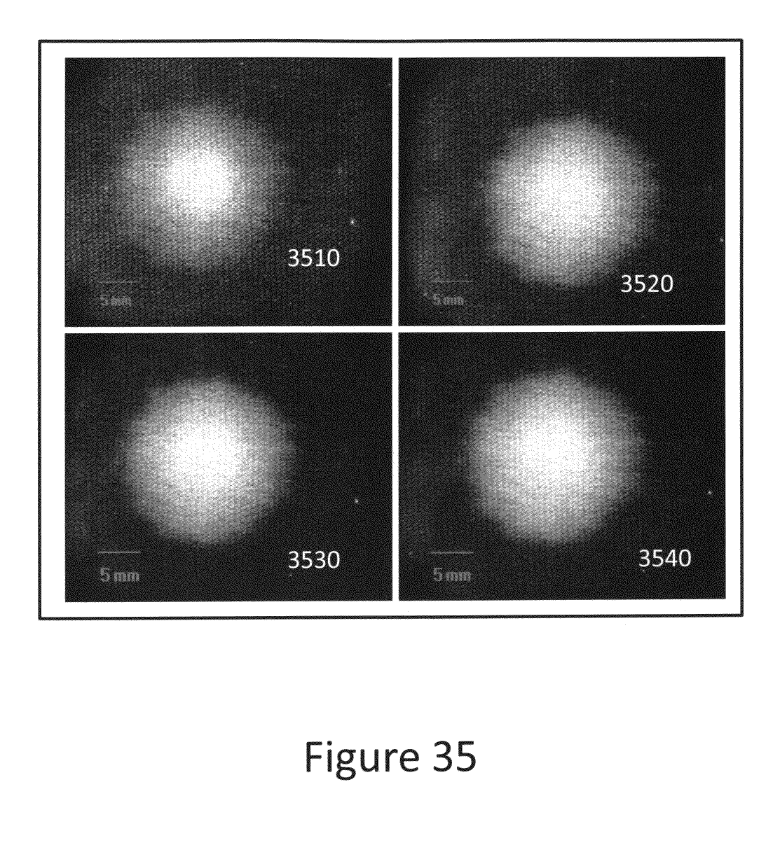

FIG. 33 illustrates gasoline on white cotton duration images: 1 week after deposition 3310, 2 weeks after deposition 3320, 3 weeks after deposition 3330, and 4 weeks after deposition 3340 at 455 nm illumination, 600 nm frame. FIG. 34 gasoline on denim duration images: 1 week after deposition 3410, 2 weeks after deposition 3420, 3 weeks after deposition 3430, and 4 weeks after deposition 3440 at 445 nm illumination, 510 nm frame, images have been normalized, and a noise reduction filter has been applied. FIG. 35 illustrates diesel fuel on white cotton duration images: 1 week after deposition 3510, 2 weeks after deposition 3520, 3 weeks after deposition 3530, and 4 weeks after deposition 3540 at 455 nm illumination, 570 nm frame.

The ability to visualize ILR stains weeks after deposition is extremely valuable as traditional ILR detection techniques are useful only in a limited timeframe before the hydrocarbon components evaporate. With evidence that is not packaged within the timeframe, or is not packaged in a way to preserve the ILRs, HSI offers a technique to detect the ILR stains when they may have otherwise been overlooked. Even if the stain is visualized after it is too late to be detected by a confirmatory technique such as GC-MS, a comparison could potentially be made to the evidence stains and a known ignitable liquid.

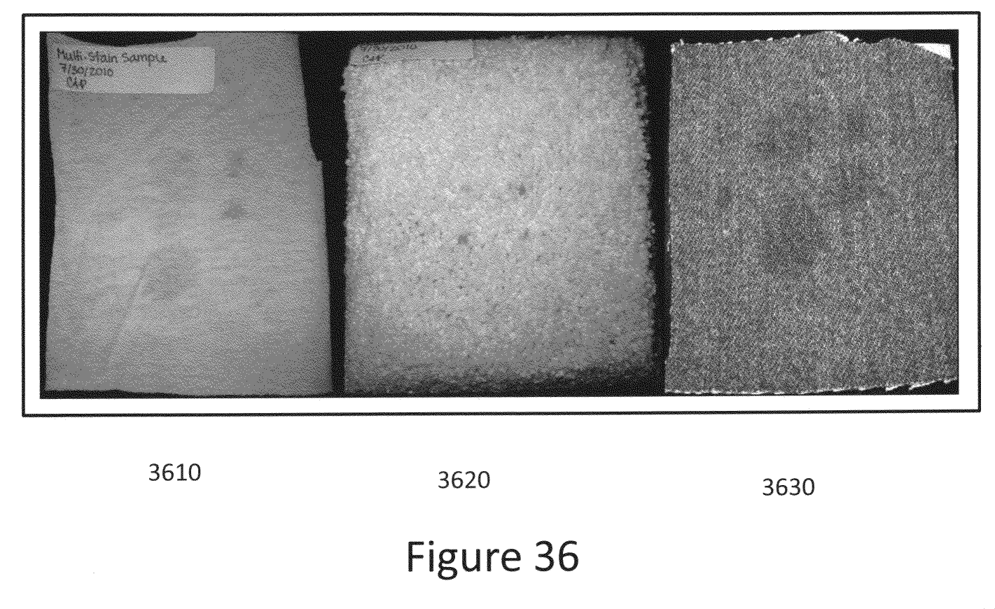

Multi-stain samples were made on white cotton, denim, and carpet 1 substrates, these samples can be seen in FIG. 36. FIG. 36 illustrates multi-stain samples from white cotton substrate 3610, carpet 1 substrate 3620, and denim substrate 3630.

Fluorescence HSI was able to visualize all the stains on the white cotton fabric as well as on the carpet substrate. Five of the nine stains were clearly visualized on the denim. All stains could be visibly distinguished from each other throughout the datacube. Specifically discussed here will be two subsets of stains which were not visible to the naked eye on the substrate, those being stains 1,2,3 and also 1,4,7 as numbered in (FIG. 7).

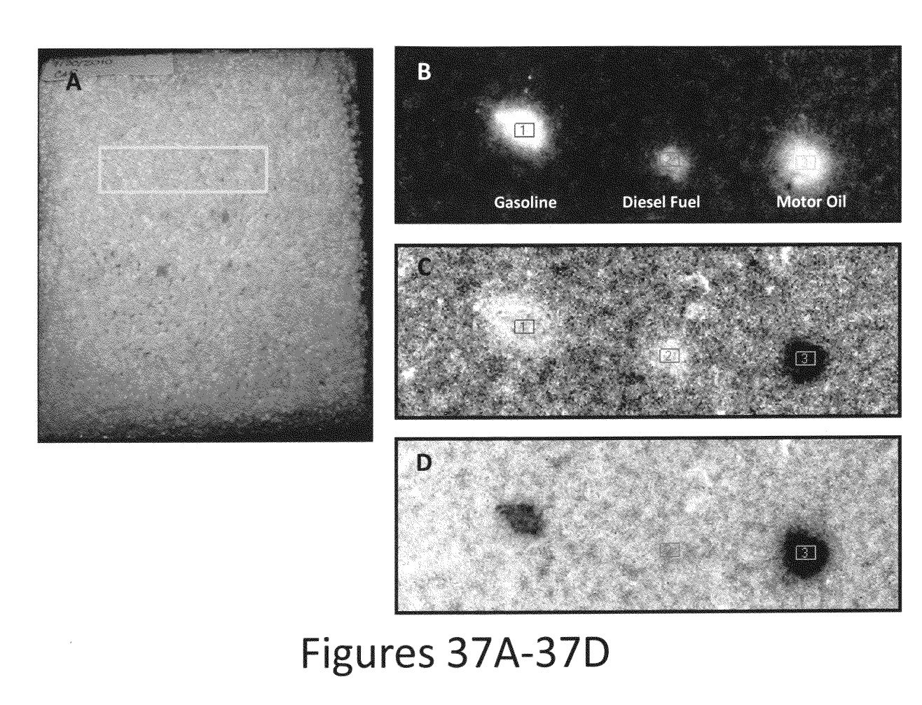

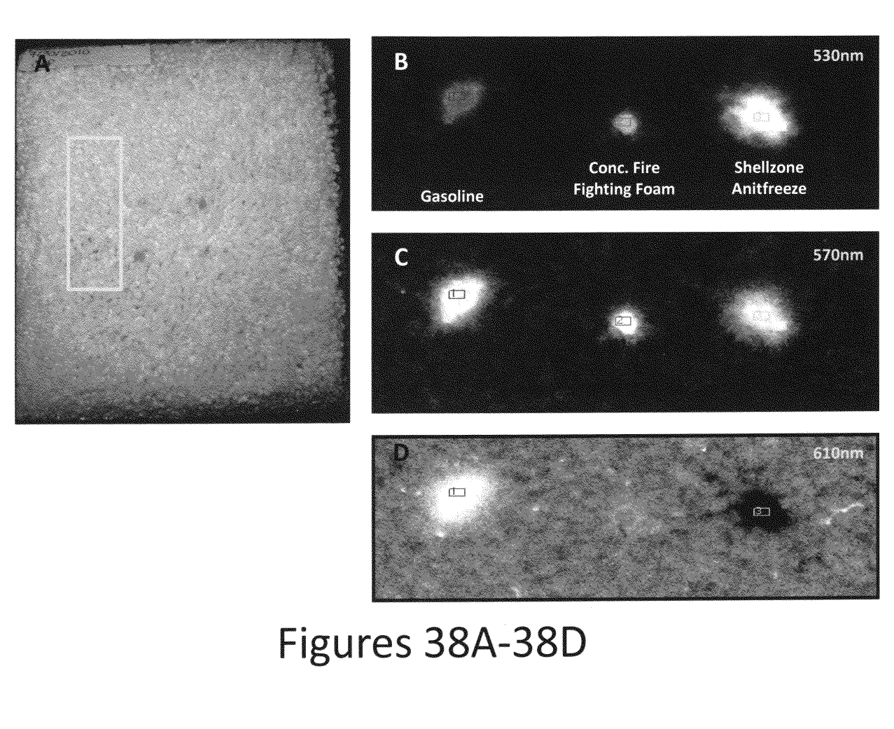

For the stain subsets, the image of all nine stains was cropped to only display stains 1-3 as one image, and stains 1,4,7 as a second image. FIG. 37A is a digital image of the carpet 1 multi-stain sample. The yellow box indicates the subset of stains 1,2, and 3. FIG. 37B is the 580 nm frame of the datacube collected for the 1,2,3 stain subset. FIG. 37C is the 630 nm frame of the 1,2,3 subset. FIG. 37D is the 640 nm frame of the 1,2,3 subset. 455 nm illumination was used for this data collection. In FIGS. 37A-37D stains 1-3 on carpet 1 can be seen at three different wavelengths, 580 nm, 630 nm, and 640 nm. In the 580 nm frame, the stains appear to be similar as all the stains are fluorescing. In the 630 nm and 640 nm frames however, the three stains can be visually distinguished. Similarly, in FIGS. 38A-38D stains 1, 4, and 7 can be seen at 530 nm, 570 nm, and 610 nm. In the 570 nm frame, all three stains appear to be fluorescing similarly, however in the 530 nm and 610 nm frames, all three can be distinguished.

FIG. 38A is a digital image of the carpet 1 multi-stain sample. The yellow box indicates the subset of stains 1,4, and 7. FIG. 38B is the 530 nm frame of the datacube collected for the 1,4,7 stain subset. FIG. 38C is the 570 nm frame of the 1,4,7 subset. FIG. 38D is the 610 nm frame of the 1,4,7 subset. 455 nm illumination was used for this data collection

When examining samples which may contain stains from multiple origins, it is especially advantageous to have images at multiple wavelengths to review. The value of being able to distinguish between multiple stains on a substrate is that it indicates the number of samples which need to be forwarded on for further definitive testing. If an examiner only looked at stains 1-3 with 455 nm illumination and 580 nm goggles, the three stains would not be distinguished and separated at that point for individual examinations.

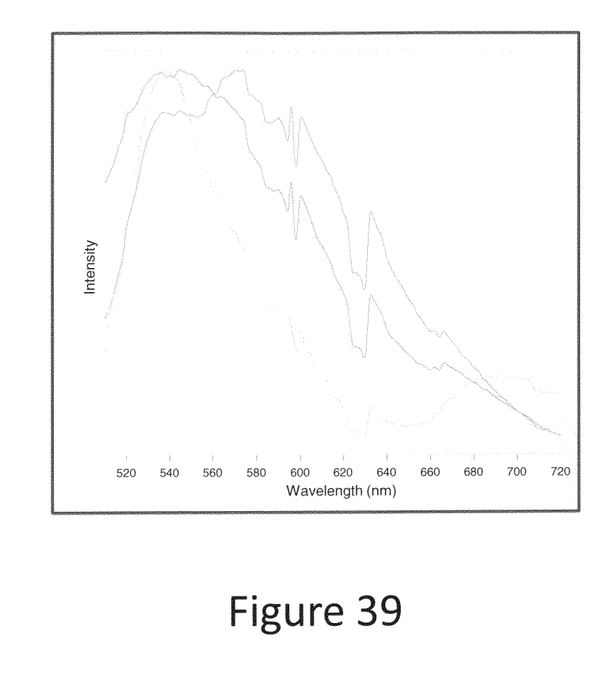

Additional data was collected at 2 nm step sizes in order to get more specific spectrum for each of the subset stains. The spectra for stain subset 1, 4, 7 is shown in FIG. 39. FIG. 39 illustrates spectra from the 2 nm step size data collection of sample subset 1, 4, 7. The blue spectrum is representative of gasoline, the red spectrum is representative of concentrated firefighting foam, and the yellow spectrum is representative of antifreeze With the stain subset of 1, 4, 7, the smaller step size collection was particularly advantageous as the three stains each gave distinctly different spectrums, especially at the beginning of the data collection range. The smaller step size collection increased the experimental time as more frames of data were being acquired, but this may prove to be beneficial in cases where there are known liquids available for spectral comparisons to be made.

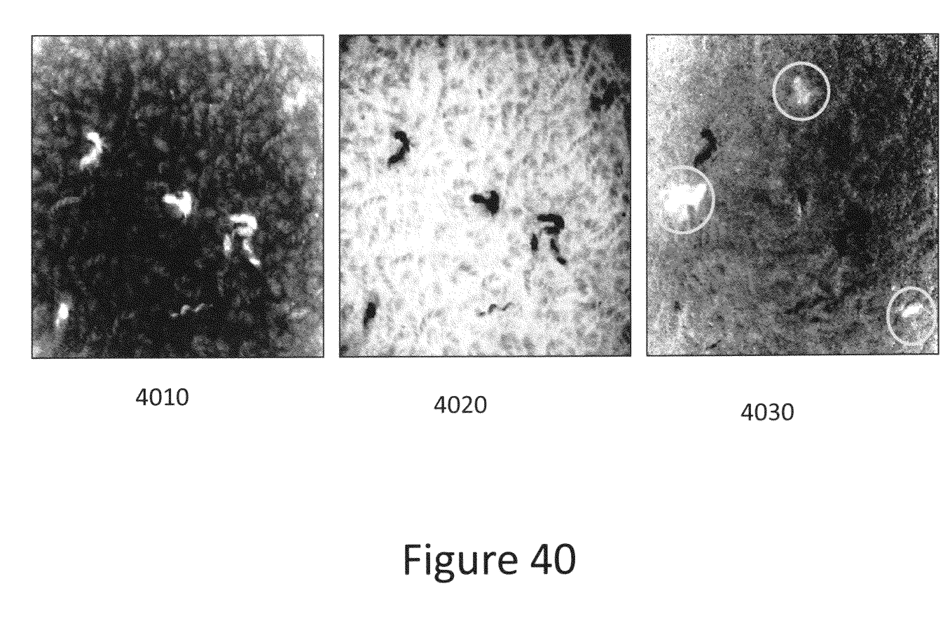

Blinded samples were made on carpet 2, carpet 1, and denim substrates, along with an additional black leather glove substrate. The samples were specifically designed by another scientist to test the LLOD limits, stain differentiation, and the effects of the fire fighting foam on the visualization of gasoline. The results of the blinded samples showed that volumes comparable to those listed as the LLOD volumes for gasoline and diesel were successfully detected and visualized. Also, gasoline was successfully visualized even after fire fighting foam had been poured over the ILR stain. HSI also successfully distinguished between stains of different chemical make ups, and the PCA processing was able to successfully classify stains of the same substance as similar. PCA processing was also useful in one blind sample at revealing 3 stains additional to those visualized with the traditional processing steps FIG. 40. In this particular sample, kerosene stains were visualized with PCA even though it did not show any fluorescence throughout the dataset.

FIG. 40 illustrates HSI images of blinded sample 1. Background divided, normalized image at 520 nm 4010. Background divided, normalized image at 660 nm 4020. PC image 4030. The yellow circles in the PC image indicate the 3 additional stains which were visualized in PCA processing, but not visible in the normalized images.

The time required to examine the blinded samples was comparable to the time required for the other sample types. Data collection time ranged from 11 to 25 minutes depending on the substrate type and the illumination wavelength used. Processing time was variable depending on the number of steps applied, however the average amount of time spent processing the data was an additional 10 minutes.

The system and method of the present disclosure holds potential value for police, forensic scientists, and arson investigators as fluorescence HSI methodology offers a novel, nondestructive method of detecting and visualizing ILRs. Fluorescence HSI holds potential for successful detection and visualization of ILR stains on both clothing and carpeting. HSI could visualize stains as small as 1 μL on multiple substrates, and dilutions down to 1:30. Furthermore, HSI could also visualize stains which had been deposited 4 weeks previous to data collection; this is especially valuable since methods of ILR detection which detect the hydrocarbon component of ILRs are limited by the hydrocarbon rate of evaporation. HSI could be especially valuable for detecting gasoline as it is the quickest to evaporate out of the three most commonly used ignitable liquids. HSI was successful at distinguishing, both visually and spectrally, between stains of different liquids, which is helpful as it gives the examiner knowledge as to how many different areas on a substrate need to be tested further. Even with ILR samples that have been detected using other methods, especially GC-MS and SPME, the ILR visual provided by HSI could be helpful in determining if the response of the other instrument was from an actual ILR stain or if it may have been due to a compound that would already have been integrated into the substrate during manufacturing, as mentioned in several publications.

The spectral portion of ILR data may be influenced by the substrate that the ILRs were deposited onto. Fluorescence HSI methodology holds potential for use as an accompaniment with another method, such as Raman or MS, which could identify a certain dye as one that is used in a specific kind of petroleum product. The visual portion of the data provides the examiner with the knowledge of knowing exactly where a stain is located on a substrate, so that only that area is submitted for further testing.

The present discourse also contemplates the examination of numerous samples of different brands and grades of gasoline and other ignitable liquids, in order to determine the ability of HSI to visualize and distinguish between different varieties of one type of ignitable liquid. Also contemplated by the present disclosure is more in depth experimentation that may hold potential for a method of visualizing the ignitable liquids on the fabrics. Further experimentation regarding possible alternative data processing techniques also hold potential for providing spectral data which is more representative of the stain in question and less influenced by the background substrate. Additionally, HSI may be applied to detect stains on washed samples.

The present disclosure may be embodied in other specific forms without departing from the spirit or essential attributes of the disclosure. Although the foregoing description is directed to the embodiments of the disclosure, it is noted that other variations and modification will be apparent to those skilled in the art, and may be made without departing from the spirit or scope of the disclosure.

What is claimed is:

1. A method comprising:
illuminating a substrate to thereby generate a first plurality of interacted photons;
collecting said first plurality of interacted photons to thereby generate at least one fluorescence data set representative of said substrate; and
analyzing said fluorescence data set to thereby determine at least one of: the presence of at least one fluorescence stain associated with an unknown substance on said substrate and the absence of at least one fluorescent stain associated with an unknown substance on said substrate.

2. The method of claim 1 wherein analyzing said fluorescence data set further comprises comparing said fluorescence data set to a reference fluorescence data set, wherein said reference fluorescence data set corresponds to a known substance.

3. The method of claim 2 wherein said known substance comprises an ignitable liquid selected from the group consisting of: gasoline, kerosene, diesel fuel, lighter fluid, and combinations thereof.

4. The method of claim 1 wherein said fluorescence data set comprises at least one fluorescence hyperspectral image.

5. The method of claim 1 wherein said fluorescence data set comprises at least one of: a fluorescence spectrum, a spatially accurate wavelength resolved fluorescence image, and combinations thereof.

6. The method of claim 1 wherein said analyzing further comprises applying at least one chemometric technique to said fluorescence data set.

7. The method of claim 6 wherein said chemometric technique comprises at least one of: principle components analysis,

8. The method of claim 6 wherein said chemometric technique comprises at least one of: partial least squares discriminate analysis, cosine correlation analysis, Euclidian distance analysis, k-means clustering, multivariate curve resolution, band t. entropy method, mahalanobis distance, adaptive subspace detector, spectral mixture resolution, Bayesian fusion, and combinations thereof.

9. The method of claim 1 wherein said fluorescence stain is associated with at least one unknown substance.

10. The method of claim 9 wherein said unknown substance comprises an ignitable liquid selected from the group consisting of: gasoline, kerosene, diesel fuel, lighter fluid, and combinations thereof.

11. The method of claim 1 further comprising passing said first plurality of interacted photons through a tunable filter to thereby filter said first plurality of interacted photons into a plurality of predetermined wavelength bands.

12. The method of claim 1 wherein said substrate comprises at least one of: a carpet sample, a clothing sample, a fabric sample, and combinations thereof.

13. The method of claim 1 wherein said analyzing further comprises determining at least one region of interest of said substrate wherein said region of interest comprises at least one fluoresce stain associated with an unknown substance.

14. The method of claim 13 further comprising:
interrogating at least one fluorescence stain associated with an unknown substance to thereby associate said fluorescence stain with a known substance.

15. The method of claim 14 wherein said interrogation further comprises assessing said fluorescence stain using at least one of: Raman hyperspectral imaging, Raman spectroscopy, GCMS, and combinations thereof.

16. The method of claim 15 wherein said known substance comprises an ignitable liquid selected from the group consisting of: gasoline, kerosene, diesel fuel, lighter fluid, and combinations thereof.

17. A system comprising:
a stage for placing a substrate under analysis;
at least one light source configured so as to illuminate said substrate to thereby generate at least one plurality of interacted photons;
a tunable filter configured so as sequentially filter at least one plurality of interacted photons into a plurality of predetermined wavelength bands; and
a first detector configured so as to detect a first plurality of interacted photons and generate at least one fluorescence data set representative of said substrate.

18. The system of claim 17 further comprising a means for analyzing said fluorescence data set to thereby determine at least one of: the presence of at least one fluorescence stain associated with an unknown substance and the absence of at least one fluorescence stain associated with an unknown substance.

19. The system of claim 17 further comprising a means for analyzing at least one fluorescence stain to thereby associate said fluorescence stain with a known substance.

20. The system of claim 17 further comprising a second detector configured so as to detect a second plurality of interacted photons and generate at least one Raman data set representative of a region of interest of said substrate.

21. A storage medium containing machine readable program code, which when executed by a processor causes said processor to perform the following:
illuminate a substrate to thereby generate a first plurality of interacted photons;
collect said first interacted photons to thereby generate at least one fluorescence data set representative of said substrate; and
analyze said fluorescence data set to thereby determine at least one of: the presence of at least one fluorescence stain associated with an unknown substance and the absence of at least one fluorescence stain associated with an unknown substance.

22. The storage medium of claim 21 which when executed by said processor further causes said processor to:
illuminate a region of interest of said substrate, wherein said region of interest comprises at least one fluorescence stain, to thereby generate a second plurality of interacted photons,
collect said second plurality of interacted photons to thereby generate at least one Raman data set representative of said region of interest, and
analyze said Raman data set to thereby associate said fluorescence stain with a known substance, wherein said known substance comprises an ignitable liquid.

23. The storage medium of claim 21 which when executed by a processor further causes said processor to: pass said first plurality of interacted photons through a tunable filter to thereby sequentially filter said first plurality of interacted photons into a plurality of predetermined wavelength bands.

24. The storage medium of claim 22 which when executed by a processor further causes said processor to pass said second plurality of interacted photons through a tunable filter to thereby sequentially filter said second plurality of interacted photons into a plurality of predetermined wavelength bands.
